(19) United States
(12) Patent Application Publication
(10) Pub. No.: US 2022/0019706 A1
(43) Pub. Date: Jan. 20, 2022

(54) DESIGN ASSIST DEVICE, DESIGN ASSIST METHOD, AND DESIGN ASSIST PROGRAM

(71) Applicant: MISUMI CORPORATION, Tokyo (JP)

(72) Inventor: Masahiro KIMURA, Tokyo (JP)

(21) Appl. No.: 17/296,513

(22) PCT Filed: Nov. 21, 2019
(86) PCT No.: PCT/JP2019/045625

§ 371 Date: May 24, 2021

(30) Foreign Application Priority Data
Nov. 30, 2018 (JP) 2018-224987

(51) Int. Cl. G06F 30/12

(52) U.S. Cl. CPC G06F 30/12; G06F 2111/20

(57) ABSTRACT

[Problem] To provide a design assist device that handles a component, wherein it is possible to prevent an unnecessary model replacement process for an altered component.

[Solution] When an indication for altering a design component is made, determination is made as to whether or not the indication of alteration falls under the category of an indication of specific alteration and, when determined as being an indication of specific alteration (Yes in STEP 1), an alteration corresponding to the indication of specific alteration is carried out without performing a model replacement process, or when determined as not being an indication of specific alteration (No in STEP 1), a model replacement process is carried out (STEP 9). The above process makes it possible to prevent an unnecessary model replacement process from being carried out, so that association between each component after alteration is maintained and the time and effort of a designer can be reduced.

### FIELD OF THE INVENTION

The present invention pertains to a design assist device, design assist method, and design assist program for assisting in the design of a design object comprised of a plurality of components.

### BACKGROUND OF THE INVENTION

Hitherto, various services taking advantage of CAD functionality have been deployed to assist designers in the design process. One example is a design assist method in which a model number replacement process of replacing model numbers with standard component model numbers in accordance with modifications to geometric data in a CAD model is performed (see Patent Document 1).

In the design assist method disclosed in Patent Document 1, a design object comprised of a plurality of components is displayed on a display device, and, when the shape of the model is modified on the display device, a search is performed to determine whether a modified component corresponds to standard component data. When standard component data exists for the modified component, a model replacement process of replacing the model on the display device with a model of the standard component is executed, and a model number replacement process of replacing the model number of the component with the model number in the standard component data is performed.

As a result of the process disclosed in Patent Document 1, when the shape of a component model is modified, the device automatically replaces the model and model number with those of the standard component, enabling a designer to order the existing standard component when ordering the modified component. This eliminates the need to check whether the modified component will need to be custom-ordered or when a general-purpose component can be used, making it possible to prevent ordering mistakes caused by mistaken model numbers when ordering.

### PRIOR ART LITERATURE

### Patent Literature

[Patent Document 1] Japanese Patent No. 6155404

### SUMMARY OF THE INVENTION

However, there are also numerous components that are used in relation with other components, such as linked components comprising a link between two components. When modifications to shape or specifications are made on a display device to a component that is related to another component in this way, a model replacement process may be performed for the component, thus removing the association between the components.

For example, when a component A and a component B are linked by a hook-shaped linking part, performing the model replacement process may alter the shape of the hook-shaped linking part. In such a case, the linkage between component A and component B would be removed.

An object of the present invention is to improve design assist devices that handle components, and, specifically, to provide a design assist device that is capable of preventing unnecessary model replacement processes being performed for components with modified shapes.

### MEANS FOR SOLVING THE PROBLEM

To these ends, a design assist device according to the present invention is a design assist device for displaying a design object comprised of a plurality of components on a display device to assist in designing the design object, the design assist device comprising: an acceptance unit for accepting a modification instruction to modify at least one of the plurality of components; a determination unit for determining whether the modification instruction corresponds to a special modification instruction that indicates a special modification to the component; a search unit for searching for a standard component that corresponds to the component as modified according to the modification instruction by referencing a storage unit containing data for a plurality of standard components that are stratified according to component types, wherein the data includes at least model numbers and reference models that represent standard shapes for the respective standard components; and a display control unit for controlling the contents displayed on the display device by selectively executing a model replacement process of replacing a display model of the unmodified component with the reference model for the standard component corresponding to the modified component, and a model number replacement process of replacing the model number of the unmodified component with the model number of the standard component corresponding to the modified component, wherein the display control unit is configured to: execute the model replacement process and the model number replacement process on the basis of the search results yielded by the search unit to display the replaced reference model and the replaced model number on the display device, when the determination unit determines the modification instruction does not correspond to the special modification instruction; and make a modification corresponding to the special modification instruction to the display model of the unmodified component without executing the model replacement process to display a modified display model on the display device when the determination unit determines the modification instruction corresponds to the special modification instruction.

In accordance with the design assist device of the present invention, it is determined whether a modification instruction for a component corresponds to a special modification instruction indicating a special modification to the component, and, if so, a model replacement process is not executed. This process makes it possible to prevent unnecessary model replacement processes, thereby retaining associations between modified components, and making it possible to reduce designer labor load.

The design assist device of the present invention may also be configured so that, when the determination unit determines the modification instruction corresponds to the special modification instruction, the determination unit further determines whether the special modification instruction is a modification instruction that entails a model number replacement, and wherein when the determination unit determines the special modification instruction is a modification instruction that entails a model number replacement, the display control unit executes the model number replacement process on the basis of the search results yielded by the search unit to display the replaced model number on the display device. This process makes it possible to reduce designer labor load by causing model numbers to conform to modifications that entail a model number replacement in the special modification instruction.

The design assist device of the present invention may also be configured so that, when the determination unit determines the special modification instruction is not modification instruction that entails a model number replacement, the display control unit does not execute the model number replacement process. This process makes it possible to prevent unnecessary model number replacement processes.

The design assist device of the present invention may also be configured so that the determination unit determines at least one type of instruction, out of modification instructions for the shape a component has as a result of its inherent function, component type, component size, component material, and location of attachment to other components, to be the special modification instruction. This process makes it possible to prevent unnecessary model replacement processes being performed for at least one of these modification instruction types.

The design assist device of the present invention may also be configured so that the component is a coil spring, and wherein the determination unit determines at least one type of instruction, out of modification instructions for a set length representing the amount of deformation in the coil spring, the maximum deflection length of the coil spring, the outer diameter of the coil spring, the free length of the coil spring, the type of the coil spring, and the material of the coil spring, to be the special modification instruction. This process makes it possible to prevent unnecessary model replacement processes being performed for at least one of these modification instruction types.

The design assist device of the present invention may also be configured so that the component is a cable carrier comprising a plurality of connected link members within which a cable is housed, the cable carrier having brackets being disposed on both ends of the link members, and being reciprocatingly moved at a predetermined stroke, and wherein the determination unit determines one type of instruction, out of modification instructions for the position of the cable carrier within the stroke, the position of a cable insertion face constituting a face of the link members into which the cable is inserted, the type of the link members, the shape of the link members, the number of links formed by the link members, the attachment direction of the brackets, and the height between the brackets, to be the special modification instruction. This process makes it possible to prevent unnecessary model replacement processes being performed for at least one of these modification instruction types.

The design assist device of the present invention may also be configured so that the component is a loop-shaped transmission member looped around a plurality of rotating members, and wherein the determination unit determines at least one type of instruction, out of modification instructions for the type of the transmission member, the width of the transmission member, the circumferential length of the transmission member, and the diameter of the rotating members, to be the special modification instruction. The rotating members are, for example, pulleys or sprockets, and the transmission member is, for example, a belt or chain. This process makes it possible to prevent unnecessary model replacement processes being performed for at least one of these modification instruction types.

The design assist device of the present invention may also be configured so that the plurality of components includes a first component and a second component that have a shared design aspect, wherein the determination unit determines a modification instruction applying to the shared design aspect of the first component to be the special modification instruction applying to the first component and the second component, and wherein when modification instruction applying to the shared design aspect of the first component are accepted, the display control unit makes a modification corresponding to the modification instruction for the shared design aspect to the display model of the unmodified first component, and makes a modification corresponding to the modification instruction for the shared design aspect to the display model of the unmodified second component, to display the modified display model of the first component and the modified display model of the second component on the display device without performing a model replacement process.

In this configuration, when a first component and a second component comprising a shared design aspect are included in the design object, and a modification instruction for the shared design aspect applying to the first component are received, the display model of the first component is modified, and, concurrently, the display model of the shared design aspect of the second component is also modified. As a result, it is not necessary to modify the shared design aspect of the second component separately from the first component. “Shared design section” refers to a second value in which one value determines another value, such as pulley diameter and the inner diameter of a belt looped around the pulley.

A design assist method according to the present invention is a design assist method for displaying a design object comprised of a plurality of components on a display device to assist in designing the design object, the method comprising: an acceptance step of accepting a modification instruction to modify at least one of the plurality of components; a determination step of determining whether the modification instruction corresponds to a special modification instruction that indicate a special modification to the component; a search step of searching for a standard component that corresponds to the component as modified according to the modification instruction by referencing a storage unit containing data for a plurality of standard components that are stratified according to component types, wherein the data includes at least model numbers and reference models that represent standard shapes for the respective standard components; and a display control step of controlling the contents displayed on the display device by selectively executing a model replacement process of replacing a display model of the unmodified component with the reference model for the standard component corresponding to the modified component, and a model number replacement process of replacing the model number of the unmodified component to the model number of the standard component corresponding to the modified component, wherein in the display control step, the model replacement process and the model number replacement process are executed on the basis of the search results yielded by the search unit, and the replaced reference model and the replaced model number are displayed on the display device, when the modification instruction is determined not to correspond to the special modification instruction in the determination step; and a modification corresponding to the special modification instruction is made to the display model of the unmodified component without executing the model replacement process, and the modified display model is displayed on the display device, when the modification instruction is determined to correspond to the special modification instruction in the determination step.

The design assist method of the present invention may also be configured so that, when the modification instruction is determined in the determination step to be corresponding to the special modification instruction, it is further determined whether the special modification instruction is a modification instruction that entails a model number replacement, and wherein when the special modification instruction is determined in the determination step to be modification instruction that entails a model number replacement, the model number replacement process is executed on the basis of the search results yielded by the search step and the replaced model number is displayed on the display device in the display control step.

The design assist method of the present invention may also be configured so that, when the special modification instruction is determined in the determination step not to be a modification instruction that entails a model number replacement, the model number replacement process is not executed in the display control step.

The design assist method of the present invention may also be configured so that, in the determination step, at least one type of instruction, out of modification instructions for the shape a component has as a result of its inherent function, component type, component size, component material, and location of attachment to other components, is determined to be the special modification instruction.

The design assist method of the present invention may also be configured so that, when the plurality of components includes a first component and a second component that have a shared design aspect, in the determination step, a modification instruction for the shared design aspect are determined to be the special modification instruction; and in the display control step, when a modification instruction applying to the shared design aspect of the first component is accepted, a modification corresponding to the modification instruction for the shared design aspect is made to the display model of the unmodified first component, and a modification corresponding to the modification instruction for the shared design aspect is made to the display model of the unmodified second component without executing the model replacement process, to display the modified display model of the first component and the modified display model of the second component are displayed on the display device.

A design assist program according to the present invention is a program for making a computer function as the design assist device according to the various aspects described above. The design assist program may be an add-on program for CAD software, a “client-server” program, or a cloud-type program, and a various types of program may be used. Moreover, the program may be installed on a server or the like, or recorded on a storage medium such as a compact disc.

### EFFECTS OF THE INVENTION

In accordance with the present invention, it is possible to provide a design assist device, a design assist method, and a design assist program that are capable of preventing unnecessary model replacement processes being performed for modified components.

### BRIEF DESCRIPTION OF THE DRAWINGS

FIG. 1 An illustration of the functional configuration of a design assist device according to an embodiment of the present invention.

FIG. 2 A flowchart of a design assist process in an embodiment of the present invention.

FIG. 3 (A) through (D) are illustrations of product selection screens for selecting a product (component).

FIG. 4 An illustration of an editing screen and an input screen displayed on a display of a designer terminal in a design assist device according to example 1.

FIG. 5 An illustration showing the details of the input screen shown in FIG. 4.

FIG. 6 (A) through (C) are illustrations showing the movement of a moving unit constituting a design object.

FIG. 7 An illustration of an input screen for entering a modification instruction for a compression-type coil spring.

FIG. 8 (A) and (B) are illustrations showing deformation in a model of a compression-type coil spring displayed on an editing screen.

FIG. 9 An illustration of an input screen for entering a modification instruction for a compression-type coil spring made of non-round wire.

FIG. 10 (A) and (B) are illustrations showing deformation in a model of a compression-type coil spring made of non-round wire displayed on an editing screen.

FIG. 11 An illustration of an editing screen and an input screen displayed on a display of a designer terminal in a design assist device according to example 2.

FIG. 12 An illustration showing the details of the input screen shown in FIG. 11.

FIG. 13 (A) through (D) are illustrations showing the shape of a cable carrier constituting a component in example 2.

FIG. 14 (A) through (C) are illustrations showing the movement of the cable carrier.

FIG. 15 An illustration of an editing screen and an input screen displayed on a display of a designer terminal in a design assist device according to example 3.

FIG. 16 An illustration showing the details of the input screen shown in FIG. 15.

FIG. 17 (A) through (C) are illustrations of the shape of a belt constituting a component in example 3.

FIG. 18 (A) and (B) are illustrations of concurrent modifications made to a belt and a pulley in a modified example of example 3.

### DETAILED DESCRIPTION OF THE INVENTION

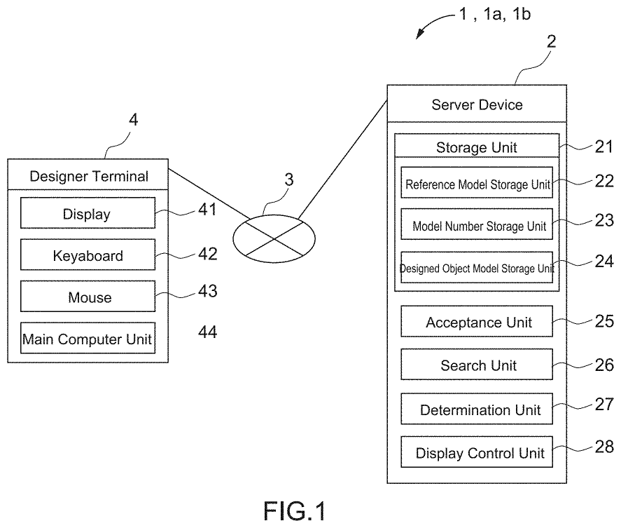

A design assist device, design assist method, and design assist program according to an embodiment of the present invention will be described with reference to FIGS. 1-18. FIG. 1 is an illustration of the functional configuration of a design assist device 1 according to an embodiment of the present invention. The design assist device 1 is a device that assists a designer in designing a design object. The design assist device 1 according to the present embodiment is realized through the server device 2 shown in FIG. 1. Specifically, the server device 2 is comprised of a computer comprising a CPU, etc., and executes a design assist program stored in a storage medium such as memory.

As shown in FIG. 1, the server device 2 is connected to a network 3 such as the Internet, and a designer terminal 4 that a designer uses to design is connected to the network 3. While only one designer terminal 4 is shown in FIG. 1, multiple terminals are present in actuality. The server device 2 comprises a storage unit 21 including a reference model storage unit 22, a model number storage unit 23, and a design object model storage unit 24. The storage unit 21 in the present embodiment corresponds to the storage unit in the present invention.

The reference model storage unit 22 stores data for a plurality of standard components stratified according to component type, the data being reference models representing standard shapes for the standard components. The model number storage unit 23 stores data for model numbers representing the model numbers of standard components related to the reference models.

The design object model storage unit 24 stores a plurality of design objects designed by combining a plurality of components. Numerous design object models are created and saved as a template set in the design object model storage unit 24 to light the burden upon designers. The storage unit 21 also stores catalog listing information not stored in the reference model storage unit 22, model number storage unit 23, or design object model storage unit 24.

The server device 2 also comprises an acceptance unit 25 that executes an acceptance process of accepting modification an instruction to modify a component when such a modification instruction is entered on the designer terminal 4. The server device 2 also comprises a search unit 26 that executes a search process of searching for a standard component corresponding to the component as modified according to the modification instruction. The acceptance unit 25 and search unit 26 in the present embodiment respectively correspond to the acceptance unit and search unit in the present invention. The acceptance process performed by the acceptance unit 25 and the search process performed by the search unit 26 in the present embodiment respectively correspond to the acceptance step and the search step in the present invention.

The server device 2 also comprises a determination unit 27 that executes a determination process of determining whether a modification instruction corresponds to a special modification instruction indicating a special modification to a component. The server device 2 also comprises a display control unit 28 that executes a display control process of controlling the contents, such as models, displayed on a display 41 of the designer terminal 4. The determination unit 27 and the display control unit 28 in the present embodiment respectively correspond to the determination unit and the display control unit in the present invention. The determination process performed by the determination unit 27 and the display control process performed by the display control unit 28 in the present embodiment respectively correspond to the determination step and the display control step in the present invention.

The display control unit 28 selectively executes a model replacement process of replacing, in predetermined conditions, a display model of an unmodified component with a reference model for a standard component corresponding to a modified component, and a model number replacement process of replacing the model number of the unmodified component with the model number of the standard component corresponding to the modified component.

The designer terminal 4 is comprised of a typical personal computer, and comprises the display 41, a keyboard 42, a mouse 43, and a main computer unit 44. The display 41 in the present embodiment correspond to the display device in the present invention. The main computer unit 44 comprises a CPU, memory, a hard disk, etc.

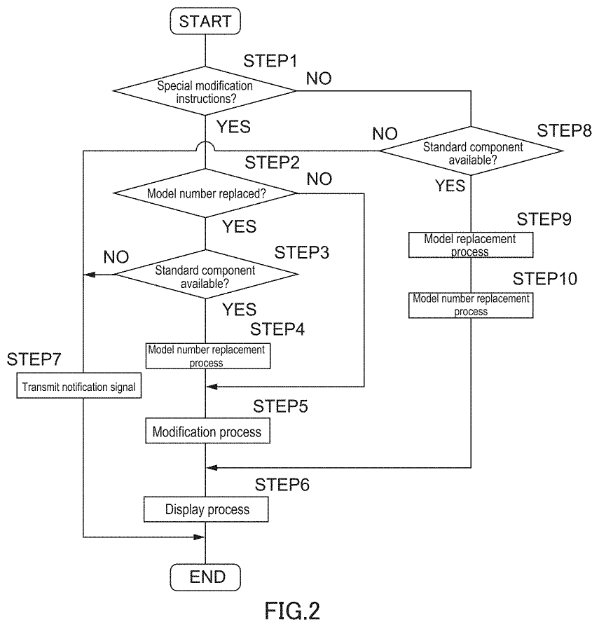

Next, a design assist process in the present embodiment will be described with reference to FIG. 2. FIG. 2 is a flowchart of a design assist process in the present embodiment. The acceptance unit 25 of the server device 2 accepts a modification instruction, entered using the keyboard 42 or mouse 43 of the designer terminal 4, to modify at least one of a plurality of components making up a model of a design object displayed on the display 41.

When the acceptance unit 25 accepts a modification instruction, the server device 2 begins the design assist process represented by the flowchart of FIG. 2. First, the determination unit 27 determines whether the modification instruction accepted by the acceptance unit 25 corresponds to a special modification instruction that indicate a special modification to the component (STEP 1).

In the present embodiment, a special modification to a component is a modification that are predesignated as not requiring a model replacement. Examples of special modifications include modifications to the shape a component has as a result of its inherent function (extension/contraction, sliding, rotation, etc.), modifications to component type, modifications to component size, modification to component material, and modifications to the location of attachment to other components. Each type of special modification instructions is also predesignated as being or not being a modification instruction that entails a model number replacement, i.e., that necessitate a model number replacement.

When the modification instruction is determined to correspond to a special modification instruction (STEP 1: YES), the determination unit further determines whether the special modification instruction is a modification instruction that entails a model number replacement (STEP 2). When the determination unit 27 determines the special modification instruction to be a modification instruction that entails a model number replacement (STEP 2: YES), the search unit 26 references the storage unit 21 to perform a search process for a standard component corresponding to the component as modified according to the modification instruction, and determines whether a corresponding standard component exists (STEP 3).

When the search unit 26 determines that a corresponding standard component does not exist (STEP 3: NO), the display control unit 28 performs a notification process of transmitting notification information that displays a screen indicating that a corresponding standard component does not exist on the designer terminal 4 (STEP: 7), and the server device 2 ends the process. The designer terminal 4 displays a screen indicating that a corresponding standard component does not exist on the display 41 in accordance with the notification information received from the server device 2.

Meanwhile, when the search unit 26 determines that a corresponding standard component does exist (STEP 3: YES), the display control unit 28 executes a model number replacement process on the basis of the search results yielded by the search unit 26 (STEP 4). Specifically, the display control unit 28 executes a model number replacement process of replacing the model number of the unmodified component with the model number of the standard component corresponding to the modified component, and generates display control information for displaying the replaced model number on the designer terminal 4.

When the model number replacement process of STEP 4 has finished, or when the special modification instruction is determined in STEP 2 not to be a modification instruction that entails a model number replacement process (STEP 2: NO), the display control unit 28 refrains from executing a model replacement process of replacing the display model of the unmodified component with the reference model for the standard component corresponding to the modified component, and executes a modification process on the display model of the component (STEP 5). Specifically, the display control unit 28 makes a modification corresponding to the special modification instruction to the display model of the unmodified component, and generates display control information for displaying the modified display model on the display 41 of the designer terminal 4. The display control unit 28 then performs a display process of transmitting the generated display control information to the designer terminal 4 (STEP 6), and the server device 2 ends the process. The designer terminal 4 modifies the contents displayed on the display 41 in accordance with the display control information received from the server device 2.

A case in which the modification instruction is determined not to correspond to a special modification instruction in STEP 1 described above (STEP 1: NO) will now be described. In this case, the search unit 26 executes a search process similar to that in STEP 3 described above (STEP 8). When the search unit 26 determines that a corresponding standard component does not exist (STEP 8: NO), the server device 2 transitions to the notification process described above (STEP 7).

Meanwhile, when the search unit 26 determines that a corresponding standard component does exist (STEP 8: YES), the display control unit 28 executes a model replacement process on the basis of the search results yielded by the search unit 26 (STEP 9). Specifically, the display control unit 28 executes a model replacement process of replacing the display model of the unmodified component with the reference model for the standard component corresponding to the modified component, and generates display control information for displaying the replaced reference model on the display 41 of the designer terminal 4. The display control unit 28 then executes a model number replacement process similar to that in STEP 4 described above (STEP 10), and the server device 2 transitions to the display process described above (STEP 6).

The design assist device 1 according to the present embodiment makes it possible to prevent unnecessary model replacement processes, thereby retaining associations between modified components, and making it possible to reduce designer labor load.

### EXAMPLE 1

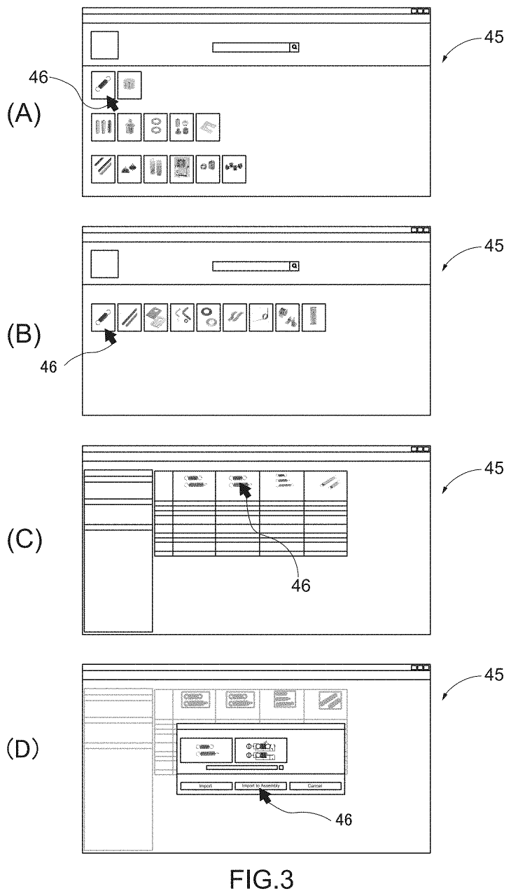

Next, an example of the design assist device 1 according to the present embodiment will be described. Example 1 is an example in which the modified component is a spring. First, a product selection screen for obtaining (importing) a reference model for a spring in the present example will be described with reference to FIG. 3. FIG. 3 is an illustration of a product selection screen for selecting a product (component).

The designer selects a component to use in a design from the product selection screen 45. The product selection screen 45 is displayed when the design assist program is started. The product selection screen 45 can also be displayed by clicking on “Model Search Screen” displayed in a model search screen 51 on an input screen 50 described below.

Specifically, the designer first displays the product selection screen 45 for selecting a product (component) on the display 41, as shown in FIG. 3(A). A pointer 46 representing the movement of the mouse 43 of the designer terminal 4 is displayed on the product selection screen 45.

To consider an example in which the designer selects a tension spring, products related to “springs” are displayed sorted into categories on the component selection screen, as shown in FIG. 3(A). The designer uses the pointer 46 to select the category “springs” from the list of categories.

When the category “springs” is selected through the operation described above, the products in that category are displayed in a list, as shown in FIG. 3(B). The designer selects the product “tension springs” from the products in the category.

When “tension springs” is selected through the operation described above, a list of series of that product is displayed, as shown in FIG. 3(C). The designer selects the product needed for the design from this list. In the case of tension springs, for example, there are four series: “extra light load, light load, light/middle load, middle load”, “middle/heavy load, heavy load”, “free designation”, and “hooked”.

When the product needed for the design is selected through the operation described above, the specifications of the product are displayed, as shown in FIG. 3(D). This enables the designer to ascertain from this screen whether the selected product is a product needed for the design. When the selected product is the product sought by the designer, the “Import to Assembly” button is selected using the pointer 46 in FIG. 3(D).

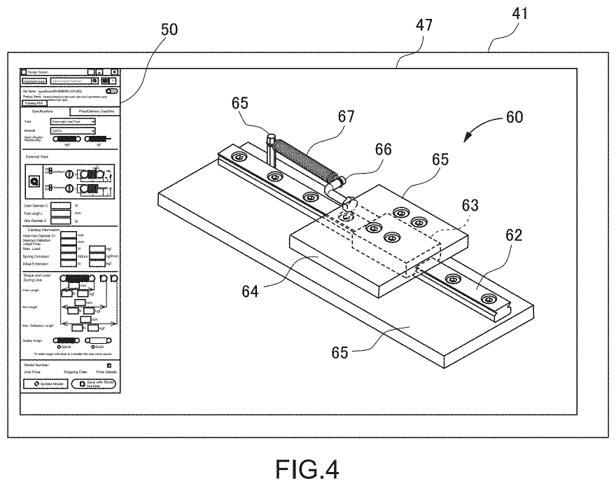

The designer then combines the models for a plurality of components obtained from the product selection screen 45 to design a design object. FIG. 4 shows an editing screen 47 and the input screen 50 displayed on the display 41 of the designer terminal 4 in the design assist device of example 1. In FIG. 4, a model of a design object 60 being designed by the designer is displayed on the editing screen 47.

The editing screen 47 in FIG. 4 will now be described. A model of a moving unit constituting an example of the design object 60 is displayed on the editing screen 47 in FIG. 4. As shown in FIG. 4, the model of the design object 60 is made up of models of a base plate 61, a rail 62, a slider 63, a plate 64, a fixed post 65, a movable post 66, and a coil spring 67.

The design object 60 is a moving unit obtained by mounting a linear guide comprising the rail 62 and the slider 63 on the base plate 61, and fixing the plate 64 to the slider 63. The rail 62 is fixed to the surface of the base plate 61. The fixed post 65 is fixed to the base plate 61, and the movable post 66 is fixed to the plate 64. The coil spring 67 is mounted between the fixed post 65 and the movable post 66.

On the editing screen 47, the designer uses CAD software functions such as mate constraints to set associations between the obtained components. For example, the designer sets an association between the coil spring 67 and the fixed post 65. Similarly, the designer sets an association between the coil spring 67 and the movable post 66.

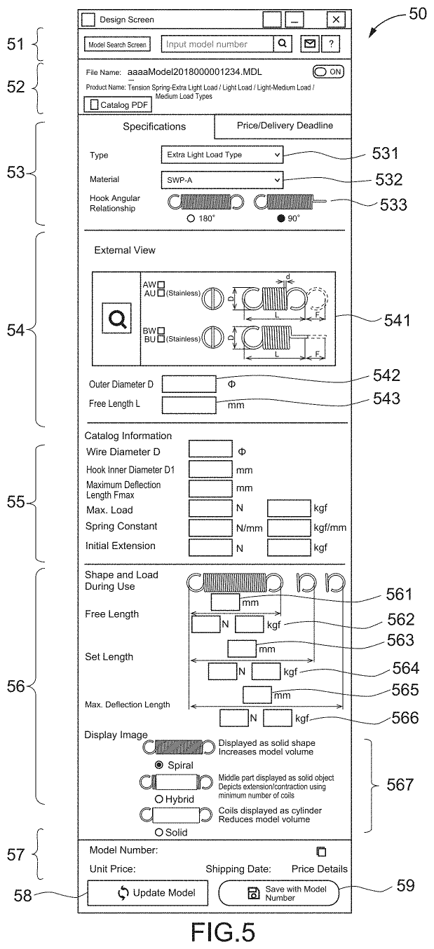

Next, the input screen 50 will be described with reference to FIG. 5. FIG. 5 is an illustration showing the details of the input screen 50 shown in FIG. 4. In example 1, the input screen 50 is displayed on the left side of the display 41, as shown in FIG. 4. Specifically, the model search screen 51, in which component model numbers can be inputted, is disposed at the top of the input screen 50, as shown in FIG. 5. A component information screen 52 in which the file name and product number of the selected component (in example 1, the coil spring 67), a button for displaying a catalog PDF file, etc., are displayed is disposed below the model search screen 51.

A component specifications screen 53 presenting information pertaining to the specifications of the selected component is disposed below the component information screen 52. In example 1, the type 531, material 532, and hook angular association 533 of the coil spring 67 are displayed in the component specifications screen 53. The component specifications screen 53 can be switched to a price/delivery deadline screen (not shown) using a switching tab.

A drop-down menu from which can be selected the load type of the coil spring 67 is displayed for type 531. A drop-down menu from which can be selected a code representing the material of the coil spring 67 is displayed for material 532. Radio buttons from which can be selected the angular association (180°/90°) of the hooks formed on the two ends of the coil spring 67 is displayed for hook angular association 533.

A component exterior screen 54 displaying information pertaining to the exterior of the selected component is disposed below the component specifications screen 53. In example 1, an external view 541, outer diameter D 542, and free length L 543 of the coil spring 67 are displayed in the component exterior screen 54. External views of coil springs 67 listed in the catalog are displayed in external view 541. External view 541 is configured not to accept inputs. A box in which a value for the outer diameter of the coil spring 67 can be inputted is displayed in outer diameter D 542. A box in which a value for the free length L of the coil spring 67 can be inputted is displayed in free length L 543.

A catalog information screen 55 displaying catalog listing information for the selected component is disposed below the component exterior screen 54. In example 1, the wire diameter, hook inner diameter, maximum deflection length, maximum load, spring constant, and initial extension of the coil spring 67 are displayed in the catalog information screen 55. Catalog values for the selected component are displayed in the catalog information screen 55, allowing a designer to obtain the necessary information regarding the selected component without having to consult an electronic or paper catalog. The catalog information screen 55 is configured not to accept inputs.

A usage/display settings screen 56 for setting usage conditions and a display image for the selected component is disposed below the catalog information screen 55. In example 1, free length 561, set length 563, maximum deflection length 565, and radio buttons 567 for selecting a display image are displayed in the usage/display settings screen 56.

The value inputted for free length L 543 in the component exterior screen 54 is displayed in free length 561. A tension 562 of the coil spring 67 when in a free length state is displayed in N (Newtons) and Kgf (kilograms-force) below the free length 561. Free length 561 and tension 562 are configured not to accept inputs.

Set length 563, in which a value representing the amount of deformation in the coil spring 67 is inputted, is displayed below tension 562. A box in which a value for the range from the free length to the maximum deflection length of the coil spring 67 can be inputted is displayed for set length 563. A tension 564 of the coil spring for the inputted set length is automatically calculated by the server device 2 and displayed below set length 563. Tension 564 is configured not to accept inputs.

Maximum deflection length 565 is displayed below tension 564. The maximum deflection length displayed here is determined by type 531 and material 532. A tension 566 of the coil spring in a maximum deflection length state is displayed below maximum deflection length 565. Maximum deflection length 565 and tension 566 are configured not to accept inputs.

The radio buttons 567 are displayed below the tension 566 of the coil spring. Radio buttons that can be used to select one of a spiral, a hybrid, and a solid display image are displayed as the radio buttons 567. When a spiral display image is selected, the model of the coil spring 67 displayed on the editing screen 47 is displayed with the as-is shape of the spring. When a hybrid display image is selected, parts of the ends of the coil spring are displayed as spring shapes, and the middle part is displayed as a cylindrical model. When a solid display image is selected, the coil spring 67 is displayed as a cylindrical model. Selecting a hybrid or solid image allows for a smaller file size than a spiral image when the design object 60 is saved as data.

A merchandise information display screen 57 in which model number, unit price, shipping date, and price details buttons are displayed is disposed below the usage/display settings screen 56. An update model button 58 and a save with model number button 59 are disposed below the merchandise information display screen 57.

In example 1, modification instructions for type 531, material 532, hook angular association 533, outer diameter D 542, free length L 543, and set length 563 on input screen 50 correspond to special modification instructions, i.e., instructions for modifications that have been predesignated as not requiring model replacements. Of these special modification instructions, modification instructions for type 531, material 532, hook angular association 533, outer diameter D 542, and free length L 543 are predesignated as modification instructions that entail model number replacements, and a modification instruction for set length 563 is predesignated as a modification instruction that does not entail a model number replacement.

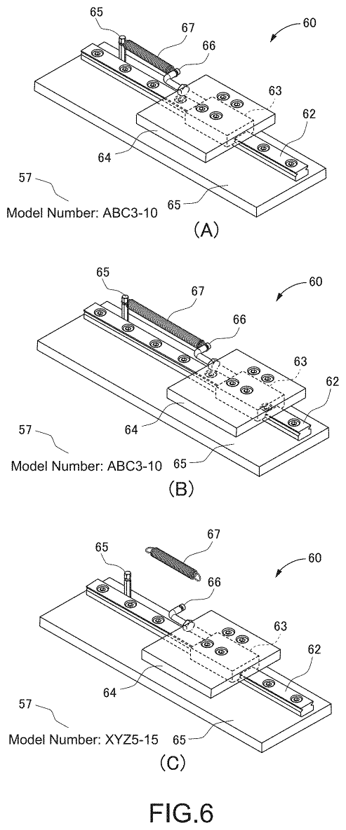

Next, a design assist process performed when using the design assist device 1 of example 1 to design the design object 60 will be described with reference to FIG. 6. FIG. 6 is an illustration showing the movement of the moving unit constituting the design object.

To design the design object 60, the designer first obtains models for the components needed for the design. Specifically, the designer starts the design assist program, displays the product selection screen 45 described above (see FIG. 3), selects the desired component, and obtains a reference model for the component. For example, when the designer selects a coil spring, the reference model for coil spring 67 is displayed on the editing screen 47.

Next, on the editing screen 47, the designer uses CAD software functions such as mate constraints to set associations between the obtained components. For example, the designer sets an association between the coil spring 67 and the fixed post 65, as shown in FIG. 6(A). Similarly, the designer sets an association between the coil spring 67 and the movable post 66.

A case will now be described in which, while the editing screen 47 including the design object 60 shown in FIG. 6(A) and the input screen 50 are being displayed, a designer inputs a desired set length for set length 563 and clicks the update button 58 to issue a modification instruction. In this case, the acceptance unit 25 of the server device 2 accepts a modification instruction for the set length. The determination unit 27 then determines the modification instruction for set length to be a special modification instruction (STEP 1 in FIG. 2: YES), and determines the modification instruction for set length to be a modification instruction that do not entail a model number replacement (STEP 2 in FIG. 2: NO).

The display control unit 28 executes a modification process of making a modification corresponding to the set length modification instruction without executing a model replacement process (STEP 5 in FIG. 2). Specifically, the display control unit 28 deforms the display model so that the length of the display model of the coil spring 67 is the set length indicated by the modification instruction. Concurrently with the deformation of the coil spring 67, the display control unit 28 modifies the displayed positions of the movable post 66, plate 64, and slider 63.

The display control unit 28 also retains the association between the coil spring 67 and the fixed post 65, and the association between the coil spring 67 and the movable post 66. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display model of the coil spring 67 in the editing screen 47 on the display 41, and the displayed position of the surrounding model, according to the display control information, as shown in FIG. 6(B).

In this case, the association between the coil spring 67 and the fixed post 65 and the association between the coil spring 67 and the movable post 66 are retained. Because the model number replacement process has not been executed, the model number “ABC3-10” displayed for the coil spring 67 on the merchandise information display screen 57 in the input screen 50 remains unchanged.

Next, a case will be described in which, while the editing screen 47 including the design object 60 shown in FIG. 6(A) and the input screen 50 are being displayed, a designer inputs a desired type into type 531 and clicks the update button 58 to issue a modification instruction for a component. In this case, the acceptance unit 25 of the server device 2 accepts a modification instruction for type. The determination unit 27 then determines the modification instruction for type to be a special modification instruction (STEP 1 in FIG. 2: YES), and determines the modification instruction for type to be a modification instruction that entails a model number replacement (STEP 2 in FIG. 2: YES).

The search unit 26 searches for a standard component corresponding to the component as modified according to the type modification instruction (STEP 3 in FIG. 2), and the display control unit 28 performs a model number replacement process of generating display control information to display the model number of the standard component corresponding to the coil spring 67 with modified type on the designer terminal 4 (STEP 4 in FIG. 2).

The display control unit 28 executes a modification process of making a modification corresponding to the type modification instruction without executing a model replacement process (STEP 5 in FIG. 2). Specifically, the display control unit 28 modifies the display model so that the type of the display model of the coil spring 67 is the type indicated by the modification instruction. The display control unit 28 also retains the association between the coil spring 67 and the fixed post 65, and the association between the coil spring 67 and the movable post 66. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the displayed model of the design object 60 in the editing screen 47 on the display 41 according to the display control information. In this case, the association between the coil spring 67 and the fixed post 65 and the association between the coil spring 67 and the movable post 66 are retained. The designer terminal 4 also replaces the model number displayed for the coil spring 67 in the merchandise information display screen 57 on the input screen 50.

When the modification instruction is a modification instruction for any of material 532, hook angular association 533, outer diameter D 542, and free length L 543, the server device 2 executes a process similar to that executed in the case of modification instruction for type 531.

Next, a case in which, while the editing screen 47 including the design object 60 shown in FIG. 6(A) and the input screen 50 are being displayed, a designer clicks the “Model Search Screen” button on the model search screen 51, and issues modification instruction for a series of coil springs 67 on the product selection screen 45 described above. In this case, the acceptance unit 25 of the server device 2 accepts a modification instruction for the series. Because a modification to series performed on the product selection screen 45 is a modification that is predesignated as not requiring a model replacement, i.e., is not a special modification, the determination unit 27 determines the series modification instruction not to be a special modification instruction (STEP 1 in FIG. 2: NO).

The search unit 26 searches for a standard component corresponding to the component as modified according to the series modification instruction (STEP 8 in FIG. 2). The display control unit 28 then performs a model replacement process of generating display control information to display the reference model of the standard component corresponding to the coil spring 67 with modified series on the designer terminal 4 (STEP 9 in FIG. 2). The display control unit 28 then generates display control information to display the model number of the standard component corresponding to the coil spring 67 with modified series on the designer terminal 4 (STEP 10 in FIG. 2).

When the display control unit 28 performs a display process of transmitting the display control information to the designer terminal 4 (STEP 6 in FIG. 2), the designer terminal 4 replaces the display model of the coil spring 67 of the designer terminal 4 in the editing screen 47 on the display 41 with the reference model for the coil spring 67 with modified series, as shown in FIG. 6(C).

In this case, the association between the coil spring 67 and the fixed post 65 and the association between the coil spring 67 and the movable post 66 are removed. The designer terminal 4 also replaces the model number “ABC3-10” displayed for the coil spring 67 in the merchandise information display screen 57 on the input screen 50 with “XYZ5-15”.

Thus, in example 1, a model replacement process is performed as in the past when a series modification instruction is issued for the coil spring 67 constituting one of the components of the design object 60, but the shape of the display model of the component displayed on the editing screen 47 is modified, without a model replacement process being performed, when a special modification instruction for the set length, etc., of the coil spring 67 is issued.

Consequently, the associations between the two end sections of the coil spring 67 and the fixed post 65 and movable post 66 are not removed when the modification instruction is determined to be a special modification instruction, thereby sparing the designer unnecessary labor, such as needing to reset associations as a result of unnecessary removal of associations.

The designer can also design the design object 60 from the outset using the CAD software installed in the designer terminal 4. The designer can also display a design object selection screen not shown in the drawings, and select and use a template similar to the design object 60 being designed from a set of templates for numerous design objects stored in the design object model storage unit 24.

### FIRST MODIFIED EXAMPLE OF EXAMPLE 1

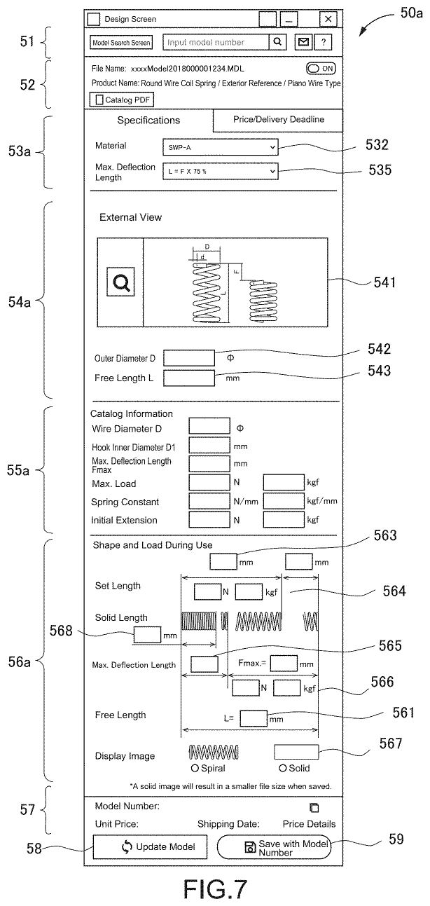

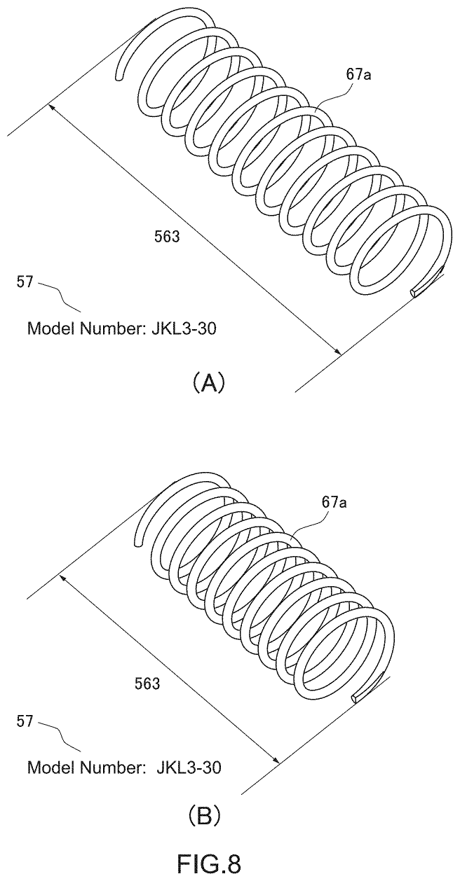

Next, a first modified example of example 1 will be described with reference to FIGS. 7 and 8. In this first modified example, a compression-type coil spring 67a is used as the spring. FIG. 7 is an illustration of an input screen 50a for issuing a modification instruction for the compression-type coil spring 67a. FIG. 8 is an illustration showing deformation in a model of a compression-type coil spring 67a displayed on an editing screen 47 (see FIG. 4).

The input screen 50a shown in FIG. 7 differs from the input screen 50 shown in FIG. 5 in that maximum deflection length 535 is provided in component specifications screen 53a, and type 531 is not provided. In the first modified example, a drop-down menu from which can be selected a set formula for the maximum deflection length of the coil spring 67a is displayed for maximum deflection length 535. The component exterior screen 54a shown in FIG. 7 differs from the component exterior screen 54 shown in FIG. 5 in that the shape of the compression-type coil spring 67a is shown in the external view 541.

Apart from these differences, the usage/display settings screen 56a shown in FIG. 7 differs from the usage/display settings screen 56 shown in FIG. 5. A box for solid length 568 is provided for the compression-type coil spring 67a. The length of the coil spring 67a when in a completely compressed state is displayed in solid length 568. Solid length 568 is configured not to accept inputs. There are display image radio buttons 567 for two types of image, spiral and solid, but a hybrid image may also be included as in FIG. 5. Apart from the differences described above, those parts of the input screen 50a shown in FIG. 7 and the input screen 50 shown in FIG. 5 that are generally identical are indicated by appending “a” to the labels used in FIG. 4, and identical parts are identically labeled, and detailed description thereof will be omitted.

In the first modified example of example 1, modification instructions for material 532, maximum deflection length 535, outer diameter D 542, free length L 543, and set length 563 on input screen 50 a correspond to special modification instructions. Of these special modification instructions, modification instructions for material 532, maximum deflection length 535, outer diameter D 542, and free length L 543 are predesignated as modification instructions that entail model number replacements, and a modification instruction for set length 563 is predesignated as a modification instruction that does not entail a model number replacement.

When the acceptance unit 25 accepts a instruction to modify the value for set length 563 in the usage/display settings screen 56a shown in FIG. 7, the determination unit 27 determines the modification instruction for set length 563 to be a special modification instruction (STEP 1 in FIG. 2: YES), and determines the modification instruction to be an instruction that does not entail a model number replacement (STEP 2 in FIG. 2: NO). The display control unit 28 only performs a modification process upon the shape of the coil spring 67a (STEP 5 in FIG. 2), and transmits, to the designer terminal 4, display control information to display the modified display model on the designer terminal 4 (STEP 6 in FIG. 2).

For example, when a designer inputs a short set length value in the display state shown in FIG. 8(A), the server device 2 performs a process similar to that described above, and a model in which the length of the coil spring 67a has been shortened is shown on the display 41 of the designer terminal 4, as shown in FIG. 8(B).

As this modification to the value for set length 563 is a special modification instruction, and does not entail a model number replacement process, there is no change in the displayed model number indicated by reference number 57 despite the change in the length (set length) of the coil spring 67a. Accordingly, even if the set length of the coil spring 67a in a design object (not shown in the drawings) including the coil spring 67a is modified, a model replacement process is not performed, thus allowing a designer to proceed with the design work unhindered.

When the acceptance unit 25 accepts a modification instruction for any of material 532, maximum deflection length 535, outer diameter D 542, and free length L 543 in the first modified example (FIG. 2, STEP 1: YES; STEP 2: YES), the server device 2 transitions to STEP 3 in FIG. 2, and executes a process similar to that performed for the coil spring 67 described above. When the acceptance unit 25 accepts a modification instruction that is not a special modification instruction, such as an instruction to modify the series of the coil spring 67a (STEP 1 in FIG. 2: NO), the server device 2 transitions to STEP 8 in FIG. 2, and executes a process similar to that performed for the coil spring 67 described above.

### SECOND MODIFIED EXAMPLE OF EXAMPLE 1

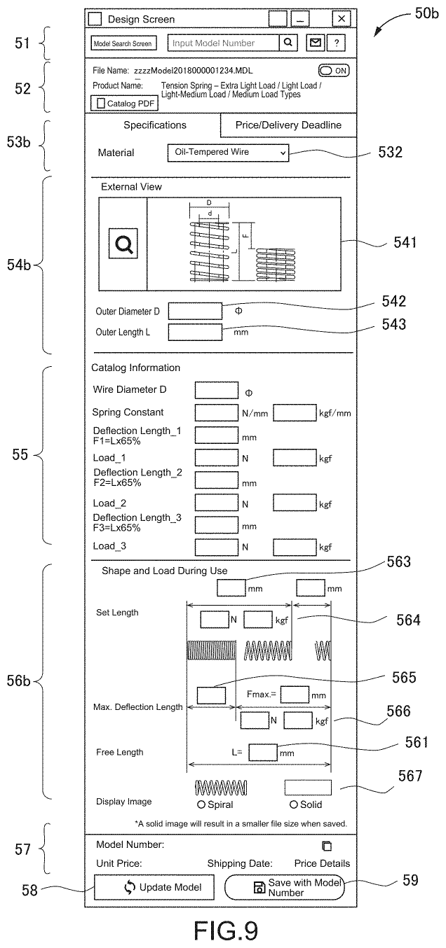

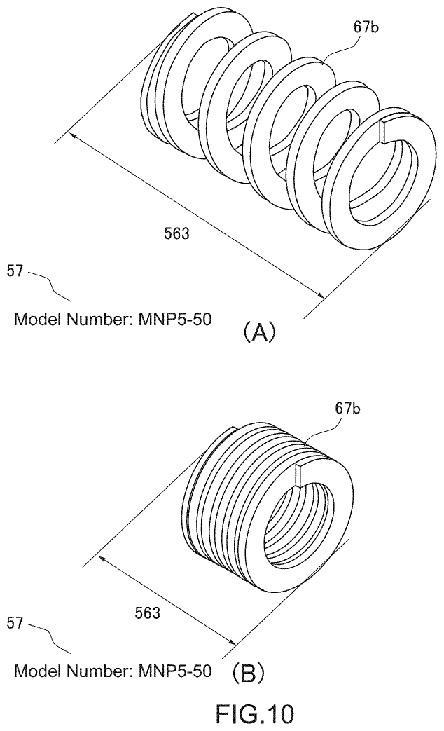

Next, a second modified example of example 1 will be described with reference to FIGS. 9 and 10. In this second modified example, a coil spring 67b comprised of a compression spring made of non-round wire is used as the spring. FIG. 9 is an illustration of an input screen 50b for issuing a modification instruction for the compression-type coil spring 67b made of non-round wire. FIG. 10 is an illustration showing deformation in a model of the compression-type coil spring 67b made of non-round wire displayed on editing screen 47 (see FIG. 4).

The input screen 50b shown in FIG. 9 differs from the input screen 50a shown in FIG. 7 in that, of the matters displayed in component specifications screen 53a in FIG. 7, only material 532 is provided in the component specifications screen 53b, and maximum deflection length 535 is not provided. The component exterior screen 54b shown in FIG. 9 differs from the component exterior screen 54a shown in FIG. 7 in that the shape of the compression-type coil spring 67b made of non-round wire is shown in the external view 541.

Apart from these differences, the usage/display settings screen 56b shown in FIG. 9 differs from the usage/display settings screen 56a shown in FIG. 7 in that a box for solid length 568 is not provided. Apart from the differences described above, those parts of the input screen 50b shown in FIG. 9, the input screen 50 shown in FIG. 4, and the input screen 50a shown in FIG. 7 that are generally identical are indicated by appending “b” to the labels used in FIG. 4, and identical parts are identically labeled, and detailed description thereof will be omitted.

In the second modified example of example 1, modification instructions for material 532, outer diameter D 542, free length L 543, and set length 563 in input screen 50b correspond to special modification instructions. Of these special modification instructions, modification instructions for material 532, outer diameter D 542, and free length L 543 are predesignated as modification instructions that entail model number replacements, and a modification instruction for set length 563 is predesignated as modification instruction that does not entail a model number replacement.

When the acceptance unit 25 accepts an instruction to modify the value for set length 563 in the usage/display settings screen 56b shown in FIG. 9, the determination unit 27 determines the modification instruction for set length 563 to be a special modification instruction (STEP 1 in FIG. 2: YES), and determines the modification instruction to be instruction that does not entail a model number replacement (STEP 2 in FIG. 2: NO). The display control unit 28 only performs a modification process upon the shape of the coil spring 67b (STEP 5 in FIG. 2), and transmits, to the designer terminal 4, display control information to display the modified display model on the designer terminal 4 (STEP 6 in FIG. 2).

For example, when a designer inputs a short set length value in the display state shown in FIG. 10(A), the server device 2 performs a process similar to that described above, and a model in which the length of the coil spring 67b has been shortened is shown on the display 41 of the designer terminal 4, as shown in FIG. 10(B).

As this modification to the value for set length 563 is a special modification instruction, and does not entail a model number replacement process, there is no change in the displayed model number indicated by reference number 57 despite the change in the length (set length) of the coil spring 67b. Accordingly, even if the set length of the coil spring 67b in a design object (not shown in the drawings) including the coil spring 67b is modified, a model replacement process is not performed, thus allowing a designer to proceed with the design work unhindered.

When the acceptance unit 25 accepts a modification instruction for any of material 532, outer diameter D 542, and free length L 543 in the second modified example (FIG. 2, STEP 1: YES; STEP 2: YES), the server device 2 transitions to STEP 3 in FIG. 2, and executes a process similar to that performed for the coil spring 67 described above. When the acceptance unit 25 accepts modification an instruction that is not a special modification instruction, such as an instruction to modify the series of the coil spring 67b (STEP 1 in FIG. 2: NO), the server device 2 transitions to STEP 8 in FIG. 2, and executes a process similar to that performed for the coil spring 67 described above.

### EXAMPLE 2

Next, an example 2 of the present invention will be described. Example 2 is an example in which the modified component is a cable carrier. As described below, the cable carrier comprises a plurality of connected link members within which a cable is housed, with brackets being disposed on both ends of the link members, and the cable carrier is reciprocatingly moved at a predetermined stroke.

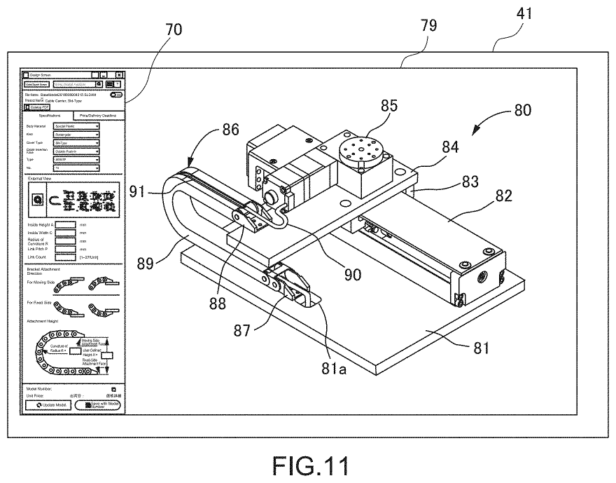

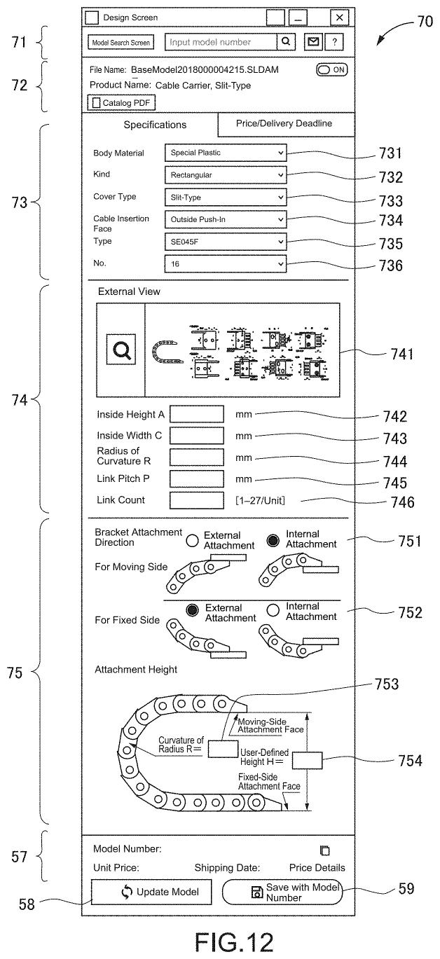

A design assist device 1a according to example 2 will now be described with reference to FIGS. 11 and 12. FIG. 11 is an illustration of an editing screen 79 and an input screen 70 displayed on the display 41 of the designer terminal 4 in the design assist device 1a of example 2. FIG. 12 is an illustration showing the details of the input screen 70 shown in FIG. 11.

In the design assist device 1a of example 2, as shown in FIG. 11, an input screen 70 for designing a cable carrier 86 for protecting a cable 90 that extends from a device is displayed on the designer terminal 4. The cable carrier 86 is formed from a plurality of linked members comprising a plurality of link members 89, and houses the cable 90 in its interior.

The design assist device 1a of example 2 comprises functional features similar to those of the design assist device 1 shown in FIG. 1, and is substantially identical in basic configuration to the design assist device 1 of example 1, but mainly the input screen 70 thereof differs from the input screen 50 of example 1.

As shown in FIG. 11, the input screen 70 in example 2 is displayed on the left side of the display 41 of the designer terminal 4. Specifically, a model search screen 71 in which component model numbers can be inputted is disposed at the top of the input screen 70, as shown in FIG. 12. A component information screen 72 in which the file name and product number of the selected component (in example 2, the cable carrier 86), a button for displaying a catalog PDF file, etc., are displayed is disposed below the model search screen 71.

A component specifications screen 73 presenting information pertaining to the specifications of the selected component is disposed below the component information screen 72. In example 2, a body material 731, kind 732, cover type 733, cable insertion face 734, type 735, and number 736 are displayed in the component specifications screen 73. The component specifications screen 73 can also be switched to a price/delivery deadline screen (not shown) using a switching tab.

The material of the link members 89 of the cable carrier 86, described below, is displayed in body material 731. The kind of shape (rectangular, round, etc.) of the link members 89 is displayed in kind 732. Slitted or not slitted is displayed in cover type 733. Body material 731, kind 732, and cover type 733 are configured not to accept inputs.

A drop-down menu from which can be selected the cable insertion method (outside push-in/inside push-in) is displayed in cable insertion face 734. A drop-down menu from which can be selected a code indicating component type is displayed in type 735. A drop-down menu from which can be selected a parameter associated with the shape of the link members 89 is displayed in number 736.

A component exterior screen 74 displaying information pertaining to the exterior of the selected component is disposed below the component specifications screen 73. In example 2, an external view 741, inside height A 742, inside width C 743, radius of curvature R 744, link pitch P 745, and link count 746 of the cable carrier 86 are displayed in the component exterior screen 74.

External views of cable carriers 86 listed in the catalog are displayed in external view 741. The height of the interiors of the link members 89, which is determined by type 735, is displayed in inside height A 742. External view 741 and inside height A 742 are configured not to accept inputs.

The width of the interiors of the link members 89, which is determined by type 735 and number 736, is displayed in inside width C 743. A catalog value for the radius of curvature of the cable carrier 86, automatically selected by the server device 2 on the basis of type 735, number 736, and a user-defined height 754 described below, is displayed in radius of curvature R 744. Inside width C 743 and radius of curvature R 744 are configured not to accept inputs.

The pitch of the link members 89, which is determined by type 735, is displayed in link pitch P 745. The link pitch P 745 is configured not to accept inputs. A box in which the number of link members 89 making up the cable carrier 86 is displayed for link count 746.

An attachment settings screen 75 in which is set the attachment state of the selected component is disposed below the component exterior screen 74. In example 2, an attachment direction 751 of a movable bracket 88, an attachment direction 752 of a fixed bracket 87, a radius of curvature R 753, and a user-defined height H 754 (height between brackets) is displayed in the attachment settings screen 75. Radio buttons with which the attachment direction (exterior attachment/interior attachment) of the movable bracket 88 can be selected are displayed for the attachment direction 751 of the movable bracket 88. Radio buttons with which the attachment direction (exterior attachment/interior attachment) of the fixed bracket 87 can be selected are displayed for the attachment direction 752 of the fixed bracket 87.

Unlike radius of curvature R 744 described above, a value automatically calculated by the server device 2 from user-defined height H 754 is displayed for radius of curvature R 753. A box in which the height between brackets, i.e., the distance between the attachment face of the fixed bracket 87 and the attachment face of the movable bracket 88, can be inputted is displayed for user-defined height H 754.

As in example 1, a merchandise information display screen 57 is disposed below the attachment settings screen 75, and an update model button 58 and save with model number button 59 are disposed below the merchandise information display screen 57.

In example 2, modification instructions for the cable insertion face 734, type 735, number 736, link count 746, attachment direction 751 of movable bracket 88, attachment direction 752 of fixed bracket 87, and user-defined height H 754 in input screen 70 correspond to special modification instructions.

Of these special modification instructions, modification instructions for cable insertion face 734, type 735, number 736, and link count 746 are predesignated as modification instructions that entail a model number replacement. Meanwhile, modification instructions for the attachment direction 751 of the movable bracket 88, the attachment direction 752 of the fixed bracket 87, and the user-defined height H 754 are predesignated as modification instructions not entailing a model number replacement.

The editing screen 79 will now be described with reference to FIG. 11. A model of a movable stage constituting an example of a design object 80 is displayed on the editing screen 79 in FIG. 11. As shown in FIG. 11, the model of the design object 80 is made up of models of a base plate 81, a direct acting actuator 82, a movable plate 84, a rotating stage 85, the cable carrier 86, and the cable 90.

The design object 80 is a movable stage formed by combining the direct acting actuator 82 affixed to the base plate 81, the movable plate 84 affixed to a slider 83 of the direct acting actuator 82, and the rotating stage 85, which is affixed to the movable plate 84 and engages in rotational movement. The cable carrier 86 is bridgingly attached to the base plate 81 and the movable plate 84.

The cable carrier 86 comprises a fixed bracket 87 affixed near a through-hole 81a formed in the base plate 81, a movable bracket 88 affixed to the movable plate 84, and a plurality of link members 89 linking the brackets. A slit 91 into which the cable 90 is inserted is provided in the link members 89.

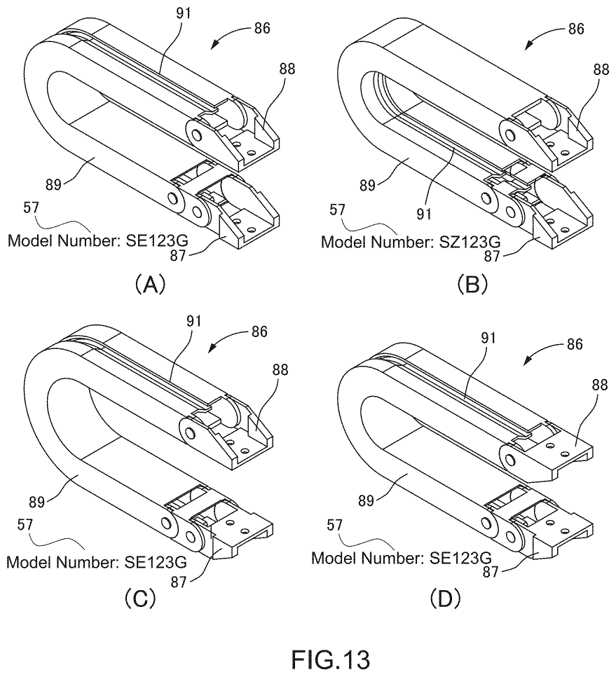

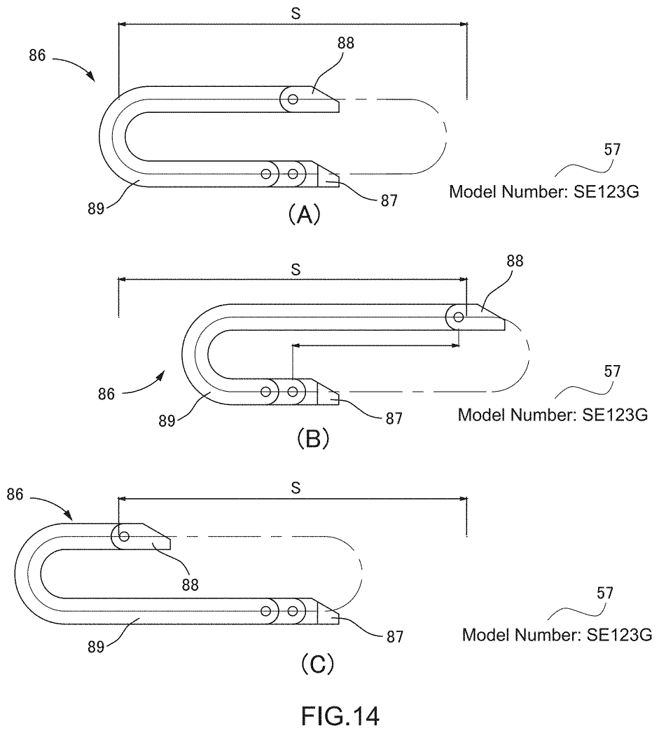

Next, a specific example of designing the design object 80 using the design assist device 1a of example 2 will be described using FIGS. 13 and 14. FIG. 13 is an illustration showing the shape of a cable carrier 86 constituting a component in example 2. FIG. 14 is an illustration showing the movement of the cable carrier 86.

To design the design object 80, the designer first uses the product selection screen 45 (see FIG. 3) to obtain models for the components needed for the design, as in example 1. For example, when the designer selects a cable carrier, the reference model for the cable carrier 86 is displayed on the editing screen 79.

Next, on the editing screen 79, the designer uses CAD software functions such as mate constraints to set associations between the obtained components. The designer sets, for example, the association between the fixed bracket 87 of the cable carrier 86 and the base plate 81, as shown in FIG. 11. Similarly, the designer sets the association between the movable bracket 88 of the cable carrier 86 and the movable plate 84.

In example 2, the cable carrier 86 shown in FIG. 13(A) and FIG. 14(A) corresponds to the cable carrier 86 shown in FIG. 11, i.e., a cable carrier 86 having set associations between the fixed bracket 87 and the base plate 81 and between the movable bracket 88 and the movable plate 84.

As shown in FIG. 13(A), “outside push-in” is set for the cable insertion face 734. The attachment direction 751 of the movable bracket 88 of the cable carrier 86 is set to “interior attachment”, and the attachment direction 752 of the fixed bracket 87 of the cable carrier 86 is set to “exterior attachment”. The link count 746 is set to 12.

In the models of the link members 89, the link member 89 linked to the fixed bracket 87 is displayed using a normal-shaped model, whereas the other link members 89 are displayed as a model having a continuous shape, as shown in FIG. 13(A). This makes it possible to simplify the display of the models of the link members 89, making the models easier to see in the editing screen 79, and reducing display processing load. The number and positions of the link members displayed using a normal-shaped model is not limited to those stated above. For example, the link member 89 linked to the movable bracket may also be displayed using a normal-shaped model. Alternatively, all of the link members 89 may be displayed using a model having a continuous shape.

A case will now be described in which, while the editing screen 79 including the design object 80 comprising the cable carrier 86 shown in FIG. 13(A) and the input screen 70 are being displayed, the designer inputs a modification of the cable insertion face 734 from “outside push-in” to “inside push-in”, and clicks the update button 58 to issue an modification instruction for the component. In this case, the acceptance unit 25 of the server device 2 accepts a modification instruction for the cable insertion face. The determination unit 27 then determines the modification instruction for cable insertion face to be a special modification instruction (STEP 1 in FIG. 2: YES), and determines the modification instruction for cable insertion face to be a modification instruction that entails a model number replacement (STEP 2 in FIG. 2: YES).

The search unit 26 searches for a standard component corresponding to the component as modified according to the cable insertion face modification instruction (STEP 3 in FIG. 2), and the display control unit 28 performs a model number replacement process of generating display control information to display the model number of the standard component corresponding to the coil spring 67 with modified type on the designer terminal 4 (STEP 4 in FIG. 2).

The display control unit 28 executes a modification process of making a modification corresponding to the cable insertion face modification instruction without executing a model replacement process (STEP 5 in FIG. 2). Specifically, the display control unit 28 modifies the display model so that the position of the slit 91 in the cable carrier 86 is on the inside. The display control unit 28 also retains the association between the fixed bracket 87 and the base plate 81, and the association between the movable bracket 88 and the movable plate 84. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display model of the cable carrier 86 in the editing screen 79 on the designer terminal 4 according to the display control information, as shown in FIG. 13(B). In this case, the association between the fixed bracket 87 and the base plate 81 and the association between the movable bracket 88 and the movable plate 84 are retained. The designer terminal 4 also replaces the model number “SE123G” displayed for the cable carrier 86 in the merchandise information display screen 57 on the input screen 70 with “SZ123G”.

When the modification instruction is a modification instruction for any of type 735, number 736, and link count 746, the server device 2 executes a process similar to that performed for modification instruction for cable insertion face 734.

Next, a case will be described in which, while the editing screen 79 including the design object 80 comprising the cable carrier 86 shown in FIG. 13(A) and the input screen 70 are being displayed, the designer inputs a modification of the attachment direction 752 of the fixed bracket 87 from “exterior attachment” to “interior attachment”, and clicks the update button model 58 to issue a modification instruction. In this case, the acceptance unit 25 of the server device 2 accepts a modification instruction for the attachment direction of the fixed bracket 87. The determination unit 27 then determines the modification instruction for the attachment direction of the fixed bracket 87 to be a special modification instruction (STEP 1 in FIG. 2: YES), and determines the modification instruction for the attachment direction to be a modification instruction that do not entail a model number replacement (STEP 2 in FIG. 2: NO).

The display control unit 28 executes a modification process of making a modification corresponding to the modification instruction for the attachment direction of the fixed bracket 87 without performing a model replacement process (STEP 5 in FIG. 2). Specifically, the display control unit 28 deforms the display model so that the orientation of the attachment face of the fixed bracket 87 corresponds to interior attachment.

The display control unit 28 also retains the association between the fixed bracket 87 and the base plate 81, and the association between the movable bracket 88 and the movable plate 84. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display model of the cable carrier 86 in the editing screen 79 on the designer terminal 4 according to the display control information, as shown in FIG. 13(C).

In this case, the association between the fixed bracket 87 and the base plate 81 and the association between the movable bracket 88 and the movable plate 84 are retained. Because the model number replacement process has not been executed, the model number “SE123G” displayed for the cable carrier 86 on the merchandise information display screen 57 in the input screen 70 remains unchanged.

The process performed when the modification instruction is for the attachment direction 751 of the movable bracket 88 is similar to that performed for a modification instruction for the attachment direction 752 of the fixed bracket 87. For example, while the editing screen 79 including the design object 80 comprising the cable carrier 86 shown in FIG. 13(C) and the input screen 70 are being displayed, the designer inputs a modification of the attachment direction 751 of the movable bracket 88 from “interior attachment” to “exterior attachment”, and clicks the update button 58 to issue a modification instruction, whereupon the server device 2 executes a process similar to that performed for the attachment direction 752 of the fixed bracket 87 described above.

The designer terminal 4 than modifies the display model of the cable carrier 86 in the editing screen 79 on the display 41, as shown in FIG. 13(D). In this case, the association between the fixed bracket 87 and the base plate 81 and the association between the movable bracket 88 and the movable plate 84 are retained. Because the model number replacement process has not been executed, the model number “SE123G” displayed for the cable carrier 86 on the merchandise information display screen 57 in the input screen 70 remains unchanged.

The server device 2 also performs a process similar to that performed for a modification instruction for the attachment direction 752 of the fixed bracket 87 when the modification instruction is for user-defined height H 754.

Next, a modification to the position of the cable carrier 86 within the stroke will be described. In example 2, the cable carrier 86 is configured to be capable of moving within a stroke S, as shown in FIGS. 14(A) through (C). The stroke S is automatically calculated by the server device 2 from type 735, link count 746, and user-defined height H 754. The range of the stroke S is displayed in correspondence with the cable carrier 86 in the editing screen 79.

FIG. 14(A) shows a state in which the movable bracket 88 is positioned substantially in the center of the stroke S of the movable plate 84. FIG. 14(B) shows a state in which the movable bracket 88 is positioned at the far end of stroke S (in FIG. 14, the right end of stroke S). FIG. 14(C) shows a state in which the movable bracket 88 is positioned at the rear end of stroke S (in FIG. 14, the left end of stroke S). In this example, the designer drags the movable bracket 88 with the mouse 43 or the like to move the movable bracket 88 within the stroke S.

A Modification instruction for the position of the cable carrier 86 within stroke S corresponds to a special modification instruction. A modification instruction for the position of the cable carrier 86 within stroke S is predesignated as a modification instruction not entailing a model number replacement. As a result, when the acceptance unit 25 accepts a modification instruction for the position of the cable carrier 86 within stroke S, the server device 2 executes a process similar to that performed for a modification instruction for the attachment direction 752 of the fixed bracket 87.

In this case, the display control unit 28 retains the association between the fixed bracket 87 and the base plate 81, and the association between the movable bracket 88 and the movable plate 84, and modifies the displayed positions of the movable plate 84 and the rotating stage 85 to match the movement of the movable plate 84. As shown in FIG. 14, the model number “SE123G” displayed for the cable carrier 86 on the merchandise information display screen 57 in the input screen 70 remains unchanged.

When the acceptance unit 25 accepts a modification instruction that is not a special modification instruction, such as an instruction to modify the series of the cable carrier 86 (STEP 1 in FIG. 2: NO), the server device 2 transitions to STEP 8 in FIG. 2, and executes a process similar to that performed in example 1 described above.

Thus, in example 2 as well, a model replacement process is not performed when a modification instruction is a special modification instruction, thereby preserving associations between components established before the modification. As a result, changes to the model not intended by the designer are prevented, thus making it possible to reduce the labor load on the designer during the design process. Unnecessary model number replacements are also avoided.

### EXAMPLE 3

Next, an example 3 of the present invention will be described. Example 3 is an example of a case in which the modified component is a belt looped around two pulleys.

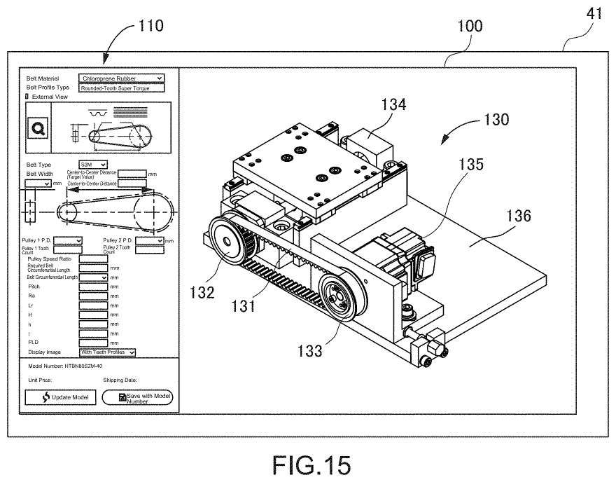

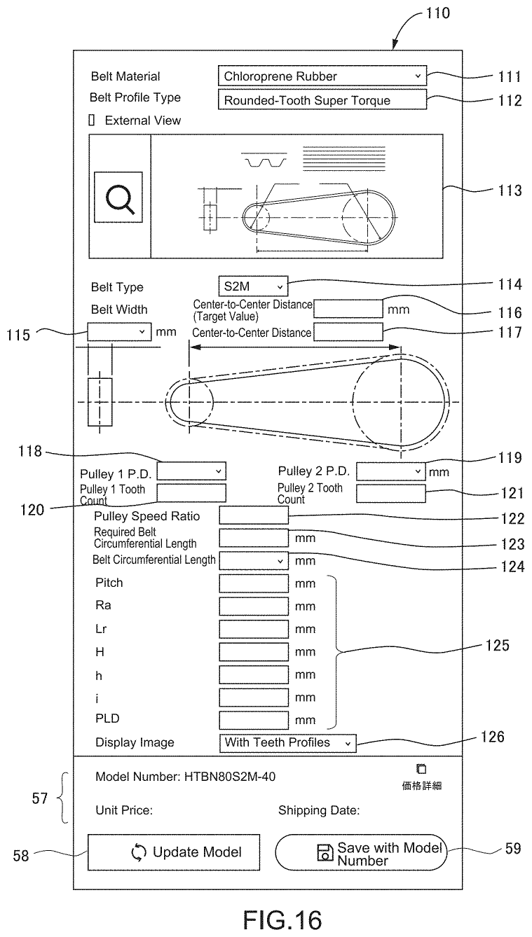

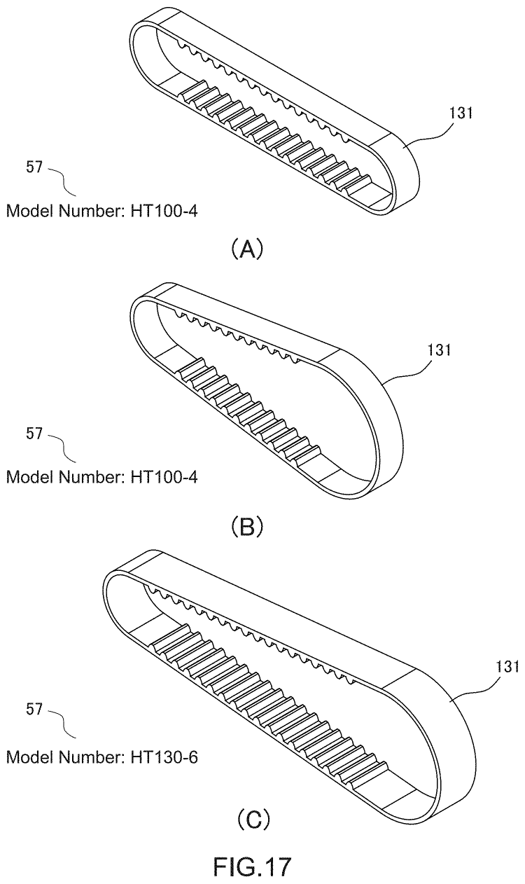

A design assist device 1b according to example 3 of the present invention will now be described with reference to FIGS. 15-17. FIG. 15 is an illustration of an editing screen 100 and an input screen 110 displayed on the display 41 of the designer terminal 4 in the design assist device 1b of example 3. FIG. 16 is an illustration showing the details of the input screen 110 shown in FIG. 15. FIGS. 17(A) through (C) are illustrations of the shape of a belt constituting a component in example 3.

In the design assist device 1b of example 3, as shown in FIG. 15, an input screen 110 for designing a belt 131 looped around a first pulley 132 and a second pulley 133 is displayed on the designer terminal 4.

The design assist device 1b of example 3 comprises functional features similar to those of the design assist device 1 shown in FIG. 1, and is substantially identical in basic configuration to the design assist device 1 of example 1, but mainly the input screen 110 thereof differs from the input screen 50 of example 1.

As shown in FIG. 15, the input screen 110 in example 3 is displayed on the left side of the display 41 of the designer terminal 4. Specifically, belt material 111, belt profile type 112, and external view 113 are displayed at the top of the input screen 110, as shown in FIG. 16. A drop-down menu from which can be selected a material used for the belt 131, such as “chloroprene rubber” or “polyurethane”, is displayed for belt material 111. Belt profile types listed in the catalog, such as “round-tooth-profile super torque” or “toothless belt”, are displayed for belt profile type 112. An external view of a belt 131 listed in the catalog is displayed in external view 113. Belt profile type 112 and external view 113 are configured not to accept inputs.

Belt type 114, belt width 115, center-to-center distance (target value) 116, and center-to-center distance 117 are displayed below external view 113. A drop-down menu from which can be selected a belt type listed in the catalog is displayed for belt type 114. A drop-down menu from which can be selected a belt width listed in the catalog is displayed for belt width 115. A box in which a value for the center-to-center distance needed when designing a design object 130 can be inputted is displayed for center-to-center distance (target value) 116. A center-to-center distance automatically calculated by the server device 2 from a pulley 1 P.D. 118 and a pulley 2 P.D. 119 described below is displayed for center-to-center distance 117. Center-to-center distance 117 is configured not to accept inputs.

A pulley 1 P.D. 118, pulley 2 P.D. 119, pulley 1 tooth count 120, pulley 2 tooth count 121 and pulley speed ratio 122 are displayed below center-to-center distance 117. A drop-down menu from which can be selected a pitch diameter for the first pulley 132 listed in the catalog is displayed for pulley 1 P.D. 118. A drop-down menu from which can be selected a pitch diameter for the second pulley 133 listed in the catalog is displayed for pulley 2 P.D. 119.

A tooth count corresponding to pulley 1 P.D. 118 listed in the catalog is displayed for pulley 1 tooth count 120. A tooth count corresponding to pulley 2 P.D. 119 listed in the catalog is displayed for pulley 2 tooth count 121. A pulley speed ratio automatically calculated by the server device 2 from pulley 1 P.D. 118 and pulley 2 P.D. 119 is displayed for pulley speed ratio 122. Pulley 1 tooth count 120, pulley 2 tooth count 121, and pulley speed ratio 122 are configured not to accept inputs.

Required belt circumferential length 123, belt circumferential length 124, and Pitch-PLD 125 are displayed below pulley speed ratio 122. A belt circumferential length automatically calculated by the server device 2 from the center-to-center distance (target value) 116, pulley 1 P.D. 118, and pulley 2 P.D. 119 is displayed for required belt circumferential length 123. A drop-down menu from which can be selected a belt circumferential length listed in the catalog is displayed for belt circumferential length 124. The pitch and various dimensions of the toothed belt 131 listed in the catalog are displayed for Pitch-PLD 125. Required belt circumferential length 123 and Pitch-PLD 125 are configured not to accept inputs.

A display image 126 is displayed below Pitch-PLD 125. A drop-down menu from which can be selected a display image 126, such as “with teeth profiles” or “without teeth profiles”, for the model of the belt 131 is displayed for display image 126. As in example 1, a merchandise information display screen 57 is disposed below the display image 126, and an update model button 58 and save with model number button 59 are disposed below the merchandise information display screen 57.

In example 3, modification instructions for belt type 114, belt width 115, pulley 1 P.D. 118, pulley 2 P.D. 119, belt circumferential length 124, and display image 126 in the input screen 110 correspond to special modification instructions. Even if a modification instruction for belt material 111 or center-to-center distance (target value) 116 is issued, the displayed model of the belt 131 remains unchanged.

Of these special modification instructions, modification instructions for belt type 114, belt width 115, and belt circumferential length 124 are predesignated as modification instructions not entailing a model number replacement. Meanwhile, modification instructions for pulley 1 P.D. 118, pulley 2 P.D. 119, and display image 126 are predesignated as modification instructions that entail a model number replacement.

The editing screen 100 will now be described with reference to FIG. 15. A model of a belt-drive actuator constituting an example of the design object 130 is displayed in the editing screen 100 shown in FIG. 15. As shown in FIG. 15, the model of the design object 130 is made up of models for the belt 131, the first pulley 132, the second pulley 133, a direct acting actuator 134, a drive motor 135, and a base plate 136.

The design object 130 is a belt-drive actuator in which the direct acting actuator 134 and the drive motor 135 are affixed to the base plate 136. The first pulley 132, which is a rotating member, is mounted on the direct acting actuator 134. The second pulley 133, which is a rotating member, is mounted on the drive motor 135.

The belt 131 constituting a transmission member is looped around the first pulley 132 and the second pulley 133. As a result of this arrangement, the drive force of the drive motor 135 is transmitted to the direct acting actuator 134 via the second pulley 133, the belt 131, and the first pulley 132.

Next, a specific example of designing the design object 120 using the design assist device 1b of example 3 will be described using FIGS. 15-17. To design the design object 130, the designer uses the product selection screen 45 (see FIG. 3) to obtain models for the components needed for the design, as in example 1. For example, when the designer selects a belt, the reference model for the belt 131 is displayed on the editing screen 100.

Next, on the editing screen 100, the designer uses CAD software functions such as mate constraints to set associations between the obtained components. The designer sets, for example, the association between the belt 131, the first pulley 132, and the second pulley 133, as shown in FIG. 15.

In example 3, the belt 131 shown in FIG. 17(A) corresponds to the belt 131 shown in FIG. 15, i.e., a belt 131 having a set association with the first pulley 132 and the second pulley 133.

The belt width of the belt 131 shown in FIG. 17(A) is set to 4 mm, the pulley 1 P.D. 118 and pulley 2 P.D. 119 are set to 9 mm, and the belt circumferential length 124 is set to 100 mm. In addition, the center-to-center distance 117 is set to 36 mm, a value automatically calculated by the server device 2 from the pulley 1 P.D. 118, pulley 2 P.D. 119, and belt circumferential length 124. The model number of the belt 131 is “HT100-4”.

A case will now be described in which, while the editing screen 100 including the design object 130 comprising the belt 131 shown in FIG. 17(A) and the input screen 110 are being displayed, the designer inputs a modification of the pulley 2 P.D. 119 of the belt 131 from 9 mm to 18 mm, and clicks the update button 58 to issue a modification instruction for the component. In this case, the acceptance unit 25 of the server device 2 accepts a modification instruction for pulley 2 P.D. 119. The determination unit 27 then determines the modification instruction for pulley 2 P.D. 119 to be a special modification instruction (STEP 1 in FIG. 2: YES), and determines the modification instruction for pulley 2 P.D. 119 to be a modification instruction that does not entail a model number replacement (STEP 2 in FIG. 2: NO).

The display control unit 28 executes a modification process of making a modification corresponding to the modification instruction for pulley 2 P.D. 119 without executing a model replacement process (STEP 5 in FIG. 2). Specifically, the display control unit 28 deforms the display model so that pulley 2 P.D. 119 is 18 mm. During this process, the display control unit 28 retains the association between the belt 131, the first pulley 132, and the second pulley 133.

Concurrently with the change in pulley 2 P.D. 119, the center-to-center distance 117 is changed to 29 mm, a value automatically calculated by the server device 2 from the pulley 1 P.D. 118, the modified pulley 2 P.D. 119, and the belt circumferential length 124. The display control unit 28 retains the association between the belt 131, the first pulley 132, and the second pulley 133, and changes the displayed positions of the first pulley 132 and the direct acting actuator 134 in accordance with the change in center-to-center distance 117. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display model of the belt 131 in the editing screen 100 on the designer terminal 4 according to the display control information, as shown in FIG. 17(B). The designer terminal 4 modifies the displayed positions of the first pulley 132 and the direct acting actuator 134 according to the display control information.

In this case, the association between the belt 131, the first pulley 132, and the second pulley 133 is retained. However, because the modification instruction for pulley 2 P.D. 119 applies to the belt 131, the diameter of the display model of the second pulley 133 remains unchanged. Therefore, a modification instruction is required for the diameter of the second pulley 133 before and after the modification instruction for pulley 2 P.D. 119. Because the model number replacement process has not been executed, the model number “HT100-4” displayed for the belt 131 on the merchandise information display screen 57 in the input screen 110 remains unchanged.

When the modification instruction is a modification instruction for either pulley 1 P.D. 118 or display image 126, the server device 2 executes a process similar to that performed for a modification instruction for pulley 2 P.D. 119.

Next, a case will be described in which, while the editing screen 100 including the design object 130 comprising the belt 131 shown in FIG. 17(B) and the input screen 110 are being displayed, the belt width 115 of the belt 131 is changed from 4 mm to 6 mm, the belt circumferential length 124 is changed from 100 mm to 130 mm, and the update button 58 is clicked to issue a modification instruction for the component. In this case, the acceptance unit 25 of the server device 2 accepts the modification instruction. The determination unit 27 then determines the modification instruction for belt width 115 and belt circumferential length 124 to be a special modification instruction (STEP 1 in FIG. 2: YES), and determines the modifications to be a modification instruction that entails a model number replacement (STEP 2 in FIG. 2: YES).

The search unit 26 searches for a standard component corresponding to the changes in belt width 115 and belt circumferential length 124 (STEP 3 in FIG. 2), and the display control unit 28 performs a model number replacement process of generating display control information to display the model number of the standard component corresponding to the modified belt 131 on the designer terminal 4 (STEP 4 in FIG. 2).

The display control unit 28 executes a modification process of making a modification corresponding to the modification instruction without executing a model replacement process (STEP 5 in FIG. 2). Specifically, the display control unit 28 modifies the display model so that, for example, belt width 115 changes from 4 mm to 6 mm. The display control unit 28 also modifies the display model so that belt circumferential length 124 changes from 100 mm to 130 mm. During this process, the display control unit 28 retains the association between the belt 131, the first pulley 132, and the second pulley 133.

Concurrently with the change in belt circumferential length 124, the center-to-center distance 117 is changed to 44 mm, a value automatically calculated by the server device 2 from the pulley 1 P.D. 118, the pulley 2 P.D. 119, and the modified belt circumferential length 124. The display control unit 28 retains the association between the belt 131, the first pulley 132, and the second pulley 133, and changes the displayed positions of the first pulley 132 and the direct acting actuator 134 in accordance with the change in center-to-center distance 117. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display model of the belt 131 in the editing screen 100 on the designer terminal 4 according to the display control information, as shown in FIG. 17(C). The designer terminal 4 modifies the displayed positions of the first pulley 132 and the direct acting actuator 134 according to the display control information.

In this case, the association between the belt 131, the first pulley 132, and the second pulley 133 is retained. The designer terminal 4 also changes the model number of the belt 131 in the merchandise information display screen 57 on the input screen 110 from “HT100-4” to “HT130-6”.

When the modification instruction is for belt type 114, the server device 2 executes a process similar to that performed for a modification instruction for belt width 115 and belt circumferential length 124.

### MODIFIED EXAMPLE OF EXAMPLE 3

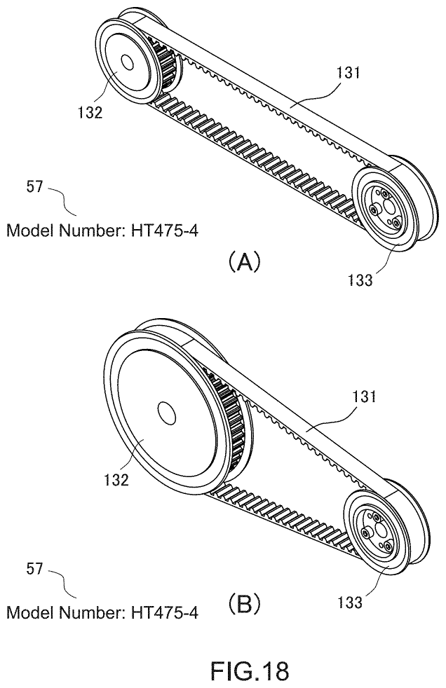

Next, a modified example of example 3 will be described with reference to FIG. 18. In the modified example of example 3, when a modification instruction for pulley diameter, which is a shared design aspect of the belt and the pulleys, is issued for either the belt or a pulley (for example, a pulley), the server device 2 executes concurrent editing by editing both one display model (for example, the pulley) and the other display model (for example, the belt). FIGS. 18(A) and (B) are illustrations of concurrent modifications made in tandem to a belt and a pulley in a modified example of example 3.

The belt width of the belt 131 shown in FIG. 18(A) is set to 10 mm, the pulley 1 P.D. 118 and pulley 2 P.D. 119 are set to 40 mm, and the belt circumferential length 124 is set to 475 mm. In addition, the center-to-center distance 117 is set to 175 mm, a value automatically calculated by the server device 2 from the pulley 1 P.D. 118, pulley 2 P.D. 119, and belt circumferential length 124. The model number of the belt 131 is “HT475-4”.

The tooth counts of the first pulley 132 and the second pulley 133 shown in FIG. 18(A) are both set to 25. The P.D. of the first pulley 132 and the P.D. of the second pulley 133 are both set to 40 mm in correspondence with the tooth count. The pulley 1 P.D. 118 of the belt 131 and the P.D. of the first pulley 132 are assigned the association of shared design aspects. Similarly, the pulley 2 P.D. 119 of the belt 131 and the P.D. of the second pulley 133 are assigned the association of shared design aspects.

When the acceptance unit 25 accepts a modification instruction to change the tooth count of the first pulley 132 to 50 while the model shown in FIG. 18(A) is being displayed on the designer terminal 4, the determination unit 27 determines the modification instruction to be a special modification instruction for the first pulley 132 (STEP 1 in FIG. 2: YES), and determines the modification instruction to be instruction that entails a model number replacement (STEP 2 in FIG. 2: YES).

The search unit 26 searches for a standard component corresponding to the first pulley 132 having the modified tooth count (STEP 3 in FIG. 2), and the display control unit 28 performs the model number replacement process described above upon the first pulley 132 (STEP 4 in FIG. 2). The server device 2 references the catalog listing information in the storage unit 21, and changes the value for the P.D. of the first pulley 132 to 80 mm, which corresponds to the modified tooth count.

The determination unit 27 determines the modification instruction to be a modification instruction for P.D., which is a shared design aspect of the belt 131 and the first pulley 132, and determines the instruction to be a modification instruction for the pulley 1 P.D. 118 of the belt 131. The determination unit 27 also determines a modification instruction for pulley 1 P.D. 118 of belt 131 to be a special modification instruction (STEP 1 in FIG. 2: YES), and determines the modification instruction to be instruction that does not entail a model number replacement (STEP 2 in FIG. 2: NO).

The display control unit 28 performs a modification process upon the shapes of the belt 131 and the first pulley 132 without executing a model replacement process (STEP 5 in FIG. 2). Concurrently with the change in pulley 1 P.D. 118, the center-to-center distance 117 of the belt 131 is changed to 143 mm, a value automatically calculated by the server device 2 from the modified pulley 1 P.D. 118, the pulley 2 P.D. 119, and the belt circumferential length 124. The display control unit 28 also generates display control information to display the modified display model on the designer terminal 4.

When the display control unit 28 performs a display process of transmitting the display control information to the designer terminal 4 (STEP 6 in FIG. 2), the designer terminal 4 modifies the display models of the belt 131, the first pulley 132, and the second pulley 133 in the editing screen 100 on the designer terminal 4 according to the display control information, as shown in FIG. 18(B). In this case, the association between the belt 131, the first pulley 132, and the second pulley 133 is retained. Because a model number replacement process has not been performed for the belt 131, the model number “HT475-4” displayed for the belt 131 on the merchandise information display screen 57 in the input screen 110 remains unchanged.

When the modification instruction is a modification instruction for the tooth count of the second pulley 133, the server device 2 executes a process of concurrently modifying the belt 131 and the second pulley 133 similar to that performed for a modification instruction for the tooth count of the first pulley 132. Likewise, when the modification instruction is a modification instruction for the pulley 1 P.D. 118 or pulley 2 P.D. 119 of the belt 131, the server device 2 executes a process of concurrently modifying the belt 131 and the first pulley 132 or second pulley 133.

Thus, in example 3 as well, a model replacement process is not performed when a modification instruction is a special modification instruction, thereby preserving associations between components established before the modification. As a result, changes to the model not intended by the designer are prevented, thus making it possible to reduce the labor load on the designer during the design process. Unnecessary model number replacements are also avoided.

While the design assist device was realized by the server device 2 in the embodiment described above, the present invention is not limited thereto. For example, it is possible to provide the designer terminal 4 with some of the acceptance unit 25, the search unit 26, the determination unit 27, and the display control unit 28 of the server device 2, and realize the design assist device through both the server device 2 and the designer terminal 4. Alternatively, the designer terminal 4 may be provided with all of the acceptance unit 25, the search unit 26, the determination unit 27, and the display control unit 28 of the server device 2 to realize the design assist device through the designer terminal 4.

While the storage unit 21 storing the information necessary for the design assist process is disposed in the design assist device (server device 2) in the embodiment described above, the present invention is not limited to such an arrangement; an arrangement in which a database comprising the storage unit 21 is installed externally to the design assist device, and the design assist device (server device 2) is configured to be capable of utilizing the information in the storage unit 21 of the database over the network 3.

While both a modification instruction entailing model number replacements and a modification instruction not entailing model number replacements are designated as special modification instructions in the embodiment described above, the present invention is not limited to such; it is acceptable to designate only modification instructions entailing model number replacements as special modification instructions. In such cases, the process of STEP 2 in FIG. 2 can be omitted. Conversely, it is acceptable to designate only modification instructions not entailing model number replacements as special modification instructions. In such cases, the processes of STEP 2 through step 4 in FIG. 2 can be omitted.

While modification instructions for set length representing the amount of deformation in the coil spring, the maximum deflection length of the coil spring, the outer diameter of the coil spring, the free length of the coil spring, the type of the coil spring, and the material of the coil spring are designated as special modification instructions in example 1 (including the first and second modified examples) described above, the present invention is not limited to such; it is acceptable to designate at least one of these types of modification instructions as a special modification instruction.

Similarly, while modification instructions for the position of the cable carrier within the stroke, the position of a cable insertion face constituting a face of the link members into which the cable is inserted, the type of the link members, the shape of the link members, the number of links formed by the link members, the attachment direction of the brackets, and the height between the brackets are designated as special modification instructions in example 2 described above, the present invention is not limited to such; it is acceptable to designate at least one of these types of modification instructions as a special modification instruction.

Similarly, while modification instructions for belt type 114, belt width 115, pulley 1 P.D. 118, pulley 2 P.D. 119, belt circumferential length 124, and display image 126 are designated as special modification instructions in example 3 described above, the present invention is not limited to such; it is acceptable to designate at least one of these types of modification instructions as a special modification instruction.

In example 3, the server device 2 calculates and changes the required belt circumferential length 123 in the input screen 110 when center-to-center distance (target value) 116 is altered, but does not alter belt circumferential length 124, and keeps the model displayed for the belt 131 unchanged; however, the present invention is not limited to such an arrangement. An arrangement is possible in which, when the center-to-center distance (target value) 116 is modified, the server device 2 automatically sets a belt circumferential length 124 most suitable for the calculated value, and modifies the belt 131 to correspond to the set belt circumferential length 124. In this case, the center-to-center distance (target value) 116 corresponds to a modification instruction that entails a model number replacement.

While the displayed model of the belt 131 remains unchanged even if the belt material 111 is modified in example 3, the present invention is not limited to such an arrangement. An arrangement is possible in which a color or pattern is preset for each belt material in the storage unit 21 of the server device 2, and, when belt material 111 is modified, the server device 2 alters the color or pattern of the model of the belt 131 to correspond to the modified belt material. In this case, the belt material 111 corresponds to a modification instruction that entails a model number replacement.

While the description of example 3 features a belt 131 as an example of a transmission member, the present invention is not limited thereto; a loop-shaped transmission member such as a chain is also acceptable. While the rotating members are a first pulley 132 and a second pulley 133 in example 3, the present invention is not limited thereto; sprockets or the like may also be used.

While the description of the modified example of example 3 features a combination of a belt and pulleys as an example of a combination of components on which concurrent modification processes are performed, the present invention is not limited thereto: any combination of a first component and a second component having a shared design aspect, such as a combination of a shaft and bearings, is acceptable.

In such a case, the determination unit 27 of the server device 2 determines a modification instruction applying to a shared design aspect of the first component to be a special modification instruction applying to the first component and the second component. When a modification instruction applying to the shared design section of the first part is accepted, the display control unit 28 makes a modification corresponding to the modification instruction for the shared design section to the display model of the unmodified first part, makes a modification corresponding to the modification instruction for the shared design section to the display model of the unmodified second part, to display the modified display model for the first part and the modified display model for the second part on the display device without performing a model substitution process. In addition, the determination unit 27 determines a modification instruction applying to a shared design aspect of the second component to be a special modification instruction applying to the first component and the second component, and the display control unit 28 executes a similar process.

While the description of the embodiment described above featured a coil spring, a cable carrier, and a belt as examples of components to which special modification instructions apply, the present invention is not limited thereto, and the features of the present embodiment can also be applied to other components, such as components comprising moving parts, or components that exhibit deformation, etc. In such a case, at least one type of instruction, out of modification instructions for shape based on intrinsic part operation, part type, part size, part material, and location of attachment to other parts, can be designated as a specific modification instruction.

### REFERENCE NUMBERS

1, 1a, 1b . . . Design assist device; 2 . . . server device; 3 . . . network; 4 . . . designer terminal; 21 . . . storage unit; 22 . . . reference model storage unit; 23 . . . model number storage unit; 24 . . . design object model storage unit; 25 . . . acceptance unit; 26 . . . search unit; 27 . . . determination unit; 28 . . . display control unit; 41 . . . display; 42 . . . keyboard; 43 . . . mouse; 44 . . . main computer unit; 45 . . . product selection screen; 46 . . . pointer; 47 . . . editing screen; 50 . . . input screen; 51 . . . model search screen; 52 . . . component information screen; 53 . . . component specifications screen; 54 . . . component exterior screen; 55 . . . catalog information screen; 56 . . . usage/display settings screen; 57 . . . merchandise information display screen; 58 . . . update button; 59 . . . save button; 60 . . . design object; 67 . . . coil spring; 70 . . . input screen; 71 . . . model search screen; 72 . . . component information screen; 73 . . . component specifications screen; 74 . . . component exterior screen; 75 . . . attachment settings screen; 79 . . . editing screen; 80 . . . design object; 86 . . . cable carrier; 87 . . . fixed bracket; 88 . . . movable bracket; 89 . . link member; 90 . . . cable; 91 . . . slit; 100 . . . editing screen; 110 . . . input screen; 111 . . . belt material; 112 . . . belt profile type; 113 . . . external view; 114 . . . belt type; 115 . . . belt width; 116 . . . center-to-center distance (target value); 117 . . . center-to-center distance; 122 . . . pulley speed ratio; 123 . . . required belt circumferential length; 124 . . . belt circumferential length; 126 . . . display image; 130 . . . design object; 131 . . . belt; 132 . . . first pulley; 133 . . . second pulley; 134 . . . direct acting actuator; 135 . . . drive motor; 136 . . . base plate.

1. A design assist device for displaying a design object comprised of a plurality of components on a display device to assist in designing the design object, the design assist device comprising a CPU, wherein the CPU is configured to:
accept a modification instruction to modify at least one of the plurality of components;
determine whether the modification instruction corresponds to a special modification instruction that indicates a special modification to the component;
search a standard component that corresponds to the component as modified according to the modification instruction by referencing a storage unit containing data for a plurality of standard components that are stratified according to component types, wherein the data includes at least model numbers and reference models that represent standard shapes for the respective standard components; and
control the contents displayed on the display device by selectively executing a model replacement process of replacing a display model of the unmodified component with the reference model for the standard component corresponding to the modified component, and a model number replacement process of replacing the model number of the unmodified component with the model number of the standard component corresponding to the modified component,
wherein the CPU is further configured to:
in the controlling, execute the model replacement process and the model number replacement process on the basis of the search results to display the replaced reference model and the replaced model number on the display device, when the modification instruction does is determined not to correspond to the special modification instruction; and
in the controlling, make a modification corresponding to the special modification instruction to the display model of the unmodified component without executing the model replacement process to display a modified display model on the display device, when the modification instruction is determined to correspond to the special modification instruction;
in the determining, further determine whether the special modification instruction is a modification instruction that entails a model number replacement when the modification instruction is determined to correspond to the special modification instruction; and
in the controlling, execute the model number replacement process on the basis of the search results to display the replaced model number on the display device when the modification instruction is determined to correspond to a modification instruction that entails a model number replacement.

2. (canceled)

3. The design assist device according to claim 1, wherein when the special modification instruction is determined not to be a modification instruction that entails a model number replacement, in the controlling, the CPU is configured not to execute the model number replacement process.

4. The design assist device according to claim 1, wherein in the determining, the CPU is configured to determine at least one type of instruction, out of modification instructions for the shape a component has as a result of its inherent function, component type, component size, component material, and location of attachment to other components, to be the special modification instruction.

5. The design assist device according to claim 1, wherein the component is a coil spring, and
wherein in the determining, the CPU is configured to determine at least one type of instruction, out of modification instructions for a set length representing the amount of deformation in the coil spring, the maximum deflection length of the coil spring, the outer diameter of the coil spring, the free length of the coil spring, the type of the coil spring, and the material of the coil spring, to be the special modification instruction.

6. The design assist device according to claim 1, wherein the component is a cable carrier comprising a plurality of connected link members within which a cable is housed, the cable carrier having brackets being disposed on both ends of the link members, and being reciprocatingly moved at a predetermined stroke, and
wherein in the determining, the CPU is configured to determine one type of instruction, out of modification instructions for the position of the cable carrier within the stroke, the position of a cable insertion face constituting a face of the link members into which the cable is inserted, the type of the link members, the shape of the link members, the number of links formed by the link members, the attachment direction of the brackets, and the height between the brackets, to be the special modification instruction.

7. The design assist device according to claim 1, wherein the component is a loop-shaped transmission member looped around a plurality of rotating members, and
wherein in the determining, the CPU is configured to determine at least one type of instruction, out of modification instructions for the type of the transmission member, the width of the transmission member, the circumferential length of the transmission member, and the diameter of the rotating members, to be the special modification instruction.

8. The design assist device according to claim 1, wherein the plurality of components includes a first component and a second component that have a shared design aspect,
wherein in the determining, the CPU is configured to determine a modification instruction applying to the shared design aspect of the first component to be the special modification instruction applying to the first component and the second component; and
wherein when the modification instruction applying to the shared design aspect of the first component is accepted, in the controlling, the CPU is configured to make a modification corresponding to the modification instruction for the shared design aspect to the display model of the unmodified first component, and makes a modification corresponding to the modification instruction for the shared design aspect to the display model of the unmodified second component without executing the model replacement process, to display the modified display model of the first component and the modified display model of the second component on the display device.

9. A design assist method for displaying by a CPU a design object comprised of a plurality of components on a display device to assist in designing the design object, the method comprising:
accepting a modification instruction to modify at least one of the plurality of components;
determining whether the modification instruction correspond to a special modification instruction that indicates a special modification to the component;
searching for a standard component that corresponds to the component as modified according to the modification instruction by referencing a storage unit containing data for a plurality of standard components that are stratified according to component types to, wherein the data includes at least model numbers and reference models that represent standard shapes for the respective standard components;
controlling the contents displayed on the display device by selectively executing a model replacement process of replacing a display model of the unmodified component with the reference model for the standard component corresponding to the modified component, and a model number replacement process of replacing the model number of the unmodified component with the model number of the standard component corresponding to the modified component,
the method further comprising:
in the controlling, executing the model replacement process and the model number replacement process on the basis of the search results to display the replaced reference model and the replaced model number on the display device, when the modification instruction is determined not to correspond to the special modification instruction; and
in the controlling, making a modification corresponding to the special modification instruction to the display model of the unmodified component without executing the model replacement process to display a modified display model on the display device, when the modification instruction is determined to correspond to the special modification instruction;
in the determining, further determining whether the special modification instruction is a modification instruction that entails a model number replacement when the modification instruction is determined to correspond to the special modification instruction; and
in the controlling, executing the model number replacement process on the basis of the search results yield in the searching to display the replaced model number on the display device when the modification instruction is determined to correspond to a modification instruction that entails a model number replacement in the determining.

10. (canceled)

11. The design assist method according to claim 8, further comprising in the controlling, not executing the model number replacement process when the special modification instruction is determined not to be a modification instruction that entails a model number replacement.

12. The design assist method according to claim 8, further comprising in the determining, determining at least one type of instruction, out of modification instructions for the shape a component has as a result of its inherent function, component type, component size, component material, and location of attachment to other components, to be the special modification instruction.

13. The design assist method according to claim 8, wherein the plurality of components includes a first component and a second component that have a shared design aspect, and further comprising:
in the determining, determining a modification instruction for the shared design aspect to be the special modification instruction, and
in the controlling, when the modification instruction applying to the shared design aspect of the first component is accepted, making a modification corresponding to the modification instruction for the shared design aspect to the display model of the unmodified first component, and making a modification corresponding to the modification instruction for the shared design aspect to the display model of the unmodified second component without executing the model replacement process, to display the modified display model of the first component and the modified display model of the second component on the display device.

14. (canceled)

15. The design assist method according to claim 8, wherein the component is a coil spring, and further comprising:
in the determining, determining at least one type of instruction, out of modification instructions for a set length representing the amount of deformation in the coil spring, the maximum deflection length of the coil spring, the outer diameter of the coil spring, the free length of the coil spring, the type of the coil spring, and the material of the coil spring, to be the special modification instruction.

16. The design assist method according to claim 8, wherein the component is a cable carrier comprising a plurality of connected link members within which a cable is housed, the cable carrier having brackets being disposed on both ends of the link members, and being reciprocatingly moved at a predetermined stroke, and further comprising:
in the determining, determining one type of instruction, out of modification instructions for the position of the cable carrier within the stroke, the position of a cable insertion face constituting a face of the link members into which the cable is inserted, the type of the link members, the shape of the link members, the number of links formed by the link members, the attachment direction of the brackets, and the height between the brackets, to be the special modification instruction.

17. The design assist method according to claim 8, wherein the component is a loop-shaped transmission member looped around a plurality of rotating members, and further comprising:
in the determining, determining at least one type of instruction, out of modification instructions for the type of the transmission member, the width of the transmission member, the circumferential length of the transmission member, and the diameter of the rotating members, to be the special modification instruction.

18. A computer readable medium including a design assist program stored thereon that when executed by a CPU causes the CPU to:
accept a modification instruction to modify at least one of the plurality of components;
determine whether the modification instruction corresponds to a special modification instruction that indicates a special modification to the component;
search a standard component that corresponds to the component as modified according to the modification instruction by referencing a storage unit containing data for a plurality of standard components that are stratified according to component types, wherein the data includes at least model numbers and reference models that represent standard shapes for the respective standard components; and
control the contents displayed on the display device by selectively executing a model replacement process of replacing a display model of the unmodified component with the reference model for the standard component corresponding to the modified component, and a model number replacement process of replacing the model number of the unmodified component with the model number of the standard component corresponding to the modified component,
in the controlling, execute the model replacement process and the model number replacement process on the basis of the search results to display the replaced reference model and the replaced model number on the display device, when the modification instruction is determined not to correspond to the special modification instruction;
in the controlling, make a modification corresponding to the special modification instruction to the display model of the unmodified component without executing the model replacement process to display a modified display model on the display device, when the modification instruction is determined to correspond to the special modification instruction;
in the determining, further determine whether the special modification instruction is a modification instruction that entails a model number replacement when the modification instruction is determined to correspond to the special modification instruction; and
in the controlling, execute the model number replacement process on the basis of the search results to display the replaced model number on the display device when the modification instruction is determined to correspond to a modification instruction that entails a model number replacement.
